(19) United States
(12) Patent Application Publication
(10) Pub. No.: US 2007/0000234 A1
(43) Pub. Date: Jan. 4, 2007

(54) Jet nozzle mixer

(76) Inventor: Jack H. Anderson, Calabasas, CA (US)

Correspondence Address: PILLSBURY WINTHROP SHAW PITTMAN, LLP, P.O. BOX 10500, MCLEAN, VA, 22102, US

(21) Appl. No.: 11/170,604

(22) Filed: Jun. 30, 2005

(51) Int. Cl. F02K 1/46

(52) U.S. Cl. 60/262; 60/770

(57) ABSTRACT

A tailcone mixer for an engine, as well as a jet engine assembly, an airplane, and methods of repairing, improving operation, and retrofitting an engine. The tailcone mixer may include a main body and a plurality of lobes. The main body may include a wider forward end and a more narrow rear end and a mid-portion extending between the forward end and the rear end. The forward end is structured and arranged for attachment to an inner duct case. The rear end is closed, and the mid-portion has a first sloping contour from the forward end to the rear end. The lobes are rigidly secured to the mid-portion. Each of the lobes has an inner section and an outer section that extend from a forward section, with the forward section being adjacent the mid-portion of the main body and the inner section extending from the forward section towards the rear end of the main body while substantially following the first sloping contour of the mid-portion of the main body. The outer section extends rearwardly from the forward section and has a second sloping contour that gradually diverges from the first sloping contour of the mid-portion.

This application is related to U.S. Non-Provisional patent application Ser. No. 10/783,839, filed Feb. 20, 2004, the entire contents of which are incorporated herein by reference.

### FIELD OF THE INVENTION

The present invention relates to jet nozzle mixers for aircraft jet engines and, in particular, to improvements in affecting a greater cooling and a lower noise level in exhaust gases emanating from such engines and in increasing power and fuel efficiency.

### DESCRIPTION OF RELATED ART AND OTHER CONSIDERATIONS

Noise (decibel) level in jet aircraft engines is established by laws and regulations, specifically promulgated by the International Civil Aviation Organization (ICAO), Annex 16. At present, commercial jet aircraft weighing over 75,000 pounds (34,000 kilograms) must meet Stage 3/Chapter 3 noise (decibel) level requirements which establish an allowable decibel noise level. Under Annex 16 Stage 4/Chapter 4 requirements, a lower maximum (decibel) level will be mandated, by at least a reduction of 10 decibels from current Stage 3/Chapter 3 levels. Such noise reduction is effected by mixing of the primary hot exhaust gases in an internal mixer with secondary bypass cooling air and by breaking of the single core of exhaust gases into a plurality of smaller cores through use of a first set of lobes positioned internally in the engine. For some engines, a second set of lobes in an external mixer is positioned downstream from the first set at the terminus of the engine. A thrust reverser module is joined to the engine housing at the engine terminus by use of an attendant mechanism covered by the STANG fairing. Because the engine has specifically designed dimensions, the second set of lobes must be configured to accommodate the existing engine design, which has a terminus exit area dimension of 1,100 square inches (7,097 square centimeters), rather than to reconfigure the engine to fit the second set of lobes. Such engine reconfiguration is impractical and expensive. Therefore, the direction towards meeting Stage 3/Chapter 3 noise requirements has been involved in developing a variously configured second set of lobes whose design does not always meet such requirements and, when the lobe design does, the lobes are difficult and expensive to manufacture and the mixer is expensive to be retrofitted to the engine.

Some engines have not employed the use of a second set of lobes or an external mixer, specifically one produced by Pratt & Whitney, in their JT8D-217/219 Series. Currently, this engine includes an internal 12 lobe mixer and is only certified to Stage 3/Chapter 3 noise levels. There has been a desire to qualify this particular engine to Stage 4/Chapter 4 noise levels, but to minimize the costs of doing so with, preferably, no changes in its thrust reversal components primarily because of cost and other economic reasons. To bring this engine to Stage 4/Chapter 4 noise levels, an additional 2 decibel reduction in jet noise is required. Such an upgrading is a challenge that has not been met.

### SUMMARY OF THE INVENTION

These and other problems are avoided and the Stage 4/Chapter 4 requirements are both met and surpassed by the present invention, not only for the above-mentioned Pratt & Whitney JT8D-217/219 Series engine but also for other engines. The second stage or external jet nozzle mixer of the present invention includes a number of lobes, which are equal in number to those of the first stage or internal mixer, and all of the second stage mixer lobes are identically formed. As the lobes axially extend outwardly from the mixer attachment to the engine nozzle, they axially inwardly expand from an essentially circular base to an undulating configuration whose apices increase in height. The lobes include complex curvatures whose interior and exterior surfaces greatly enhance mixing respectively of the previously mixed bypass cooling air-hot exhaust gases from the internal mixer and additional ambient cooling air, and thereby also reduce noise. At their terminus, the area encompassed by the lobes remains essentially the same (1,065 to 1,120 sq. inches) as for the jet engine for which it is designed which, for the Pratt & Whitney JT8D-217/219 Series engine, is 1,095 to 1,105 square inches (6,089 to 7,097 square centimeters). For other engines, the lobe terminus area is consistent with that of the engine in question.

For the Pratt & Whitney JT8D-217/219 Series engine, for example, the external mixer length is 12 inches ±3 inches (30.45 cm ±8 cm). The essentially circular base of the lobes at the mixer inlet has a linear dimension of 39.7 inches (101 centimeters) round, providing an area of 1,223 sq. inches (7,891 square centimeters). At the mixer outlet at the full height of the regularly undulating lobes, the dimension of the mixer circumscribing the lobes at their greatest height is also 39.7 inches (101 centimeters) diameter but, because of the scalloped lobe shape, the area enclosed by the lobes is 1,065 to 1,120 sq. inches (6,089 to 6,403 square centimeters), which matches the area of the existing tailpipe.

The exit shape has elliptical shaped lobes and is proportional to a 10×2.5 ellipse (plus or minus 2 inch major axis, and ±0.5 inch minor axis). These curve sides help resist distortion caused by the exhaust gas pressure.

Consistent with the above discussion, a design parameter is to shape the external mixer of the present invention with a generally cylindrical configuration and with as short a length as possible, so that it does not interfere with the existing thrust reverser doors at the end of the tailpipe. As a result, the mixer of the present invention permits the use of existing thrust reversers without necessitating any modification thereto. Only a part of the STANG fairings need to be slightly decreased in their inner dimensions to accommodate the internal mixer. Also, the existing tailpipe is shortened by about 5 inches (12.7 centimeters).

Functionally, the interior surfaces of the lobes force the impinging hot gases, as previously mixed with the secondary bypass cooling air by the first set of lobes of the internal mixer, in all directions towards the interior of the mixer, essentially 45° to 60°, to effect a vigorous mixing of the gases. Simultaneously, additional ambient cooling air is forced from the exterior surfaces of the lobes to mix further with the internally mixed gases. These actions cause the smaller gas cores, which were formed by the first stage mixer, to break into innumerable forms which are both cooler and considerably noise attenuated. In part, the internal contours of the lobes act as flutes to produce a lifting effect which causes the primary hot and cold flows to mix before entering the nozzle. The external contours of the lobes act as chutes which produce a venturi effect and accelerate the cooler secondary flow of ambient air. The lobes thereby act collectively as an injector to force the cooler ambient secondary flow into the previously mixed primary flow as it exits the nozzle. These actions further reduce the noise level. Further, the curve sides of the lobes help resist distortion caused by the exhaust gas pressure. An ameliorative further result is that the accelerated gas/air flow helps to faster move large, previously slowed mixtures to increase the efficiency of the jet engine, by increasing its thrust, that is, an increased thrust specific fuel consumption (TSFC) is estimated to be about a 3% improvement. Such increased TSFC occurs through better dynamic mixing of the bypass or fan duct and turbine exhaust gases. It addresses the problem of the transfer from a hot, high velocity volume to a cooler, slower velocity volume. This mixing levels the disparate flow velocities attendant with the jet engine exhaust, reduces the peak velocities from the jet engine core and increases the lower bypass velocities of the jet engine internal bypass flow. Because noise is a function of jet exhaust velocity to the 7th power, and because peak velocities from the core flow are reduced, the jet noise is thereby reduced.

As stated above, the axial length of the mixer of the present invention is 12 inches ±3 inches, which means that there is a lesser distance between the nozzle exit and the buckets of the thrust reverser. The effect of such decreased distance is that more of the thrust from the engine is captured by the buckets and thus utilized to brake the aircraft when needed.

The jet nozzle mixer of the present invention may fit within and be attachable to the existing engine exit whose area which, as stated above, is 1,095-1,105 square inches (6,261-7,129 square centimeters) exit area for the Pratt & Whitney JT8D-217/219 Series engine. The lobes of the present invention can be made uniform and easily tailored to provide an efficient mixing of the exhaust gases with the ambient air and the attendant reduction in noise. Its uniform dimensions enables its manufacturing costs to be reduced. The need to modify the existing thrust reverser per se is avoided because the mixer is fittable and attachable to the existing engine exit; only minor dimensional changes in the existing STANG fairing, and tailpipe and outer barrel are required without otherwise needing any change in other components such as the thrust reverser, the thrust reverser doors, and their linkages. Efficiency in jet engine operation is increased, with concomitant saving of fuel and costs thereof. Thrust reverser braking of the aircraft is improved.

Another aspect of the subject invention is a tailcone for an engine, comprising a main body having a wider forward end and a more narrow rear end and a mid-portion extending between the forward end and the rear end, the forward end being structured and arranged for attachment to an inner duct case, the rear end being closed, and the mid-portion having a first sloping contour from the forward end to the rear end; and lobes rigidly secured to the mid-portion, each of the lobes having an inner section and an outer section that extend from a forward section, the forward section being adjacent the mid-portion of the main body, the inner section extending from the forward section towards the rear end of the main body while substantially following the first sloping contour of the mid-portion of the main body, the outer section extending rearwardly from the forward section and having a second sloping contour that gradually diverges from the first sloping contour of the mid-portion.

Another aspect of the invention is a jet engine assembly, comprising: an outer duct; an inner duct positioned within the outer duct; a first noise reducing device positioned between the inner and outer ducts; a tailcone rigidly secured to a rear end of the inner duct, the tailcone having a main body and including a second noise reducing device protruding from the main body between the main body and the outer duct.

Another aspect of the invention includes a jet engine assembly, comprising: an outer duct; an inner duct positioned within the outer duct; a first air mixer positioned between the inner and outer ducts; means rigidly attached to a rear end of the inner duct and positioned within the outer duct for further mixing air and reducing noise.

Another aspect of the invention includes an airplane, comprising: a main aircraft body; and an engine assembly coupled to the main body, the engine assembly including: an outer duct; an inner duct positioned within the outer duct; a first mixer positioned between the inner and outer ducts; a tailcone rigidly secured to a rear end of the inner duct, the tailcone having a main tailcone body and including a second mixer protruding from the main tailcone body between the main tailcone body and the outer duct.

Another aspect of the invention includes a method of repairing an engine, comprising: providing an engine and a first mixer coupled to the engine, the first mixer being positioned in a housing and adapted to mix hot engine air with other air; and repairing the engine in order to decrease engine noise, increase fuel efficiency, or reduce exhaust temperature by attaching a second mixer to the rear end of an inner duct positioned within the housing, the second mixer forming an extension from a main body of a tailcone.

Another aspect of the invention includes a method of improving operation of an engine, comprising: providing an engine enclosed within a housing, the housing having an exhaust aperture, and a first mixer coupled to the engine and located within the housing, the first mixer including first elements to mix exhaust gas with cooling air; and attaching a tailcone mixer to the rear end of an inner duct that is positioned within the housing, the tailcone mixer having second elements to mix exhaust from the first mixer and form tailcone for the engine.

Another aspect of the invention includes a method of retrofitting a pre-existing engine assembly, comprising: providing a pre-existing engine enclosed within a housing, and a first mixer coupled to the pre-existing engine and being located within the housing, the first mixer including first elements to mix exhaust gas with cooling air, the housing having a pre-existing tailcone attached to the rear end of an inner duct that is positioned within the housing; removing the pre-existing tailcone; and attaching a tailcone mixer to the rear end of the inner duct, the tailcone mixer mixing exhaust from the first mixer.

Other aims and advantages, as well as a more complete understanding of the present invention, will appear from the following explanation of an exemplary embodiment and the accompanying drawings thereof. With respect to the above description then, it is to be realized that the optimum dimensional relationships for the parts of the invention are to include variations in size, materials, shape, form, function and manner of operation, assembly and use, are deemed readily apparent and obvious to one skilled in the art. As such all equivalent relationships to those illustrated in the drawings and described in the specification are intended to be encompassed by the present invention. It is important, therefore, that the claims be regarded as including such equivalent construction insofar as they do not depart from the spirit and scope of the present invention.

### BRIEF DESCRIPTION OF THE DRAWINGS

FIGS. 1a and 1b are perspective views of an end portion of a jet engine nozzle assembly to which is attached both a thrust reverser and a second stage external jet nozzle mixer as embodied in the present invention.

FIG. 2 is schematic drawing illustrating the interior of the jet engine shown in FIG. 1 with a known first stage internal mixer in the interior of the engine and the second stage inventive external jet nozzle mixer at the terminus of the engine, including the decrease in distance between the jet nozzle mixer of the present invention and the thrust reverser buckets, as compared to its non-use.

FIG. 3a is a view of the engine and its internal mixer shown in FIG. 2 taken along line 3-3 thereof, and FIG. 3b is a perspective view of the cone and surrounding vanes of the internal mixer.

FIG. 4 is a perspective view of the second stage, external mixer assembly of the present invention in which its twelve identically shaped lobes are seen. The four undulating cross-sections, #1 through #4, which variously pass through the lobes of the mixer and which extend from the end of the mixer assembly towards its point of attachment to the terminus of the engine, are representative of all planes which pass through all of the lobes. A fifth cross-section #5, which is circular, extends about the band which anchors the mixer to the engine terminus. A sixth cross-section #6 is positioned behind the plane of the fifth cross-section #5, and is seen in subsequent figures. These six cross-sections are referred to in subsequent figures as defining planes numbered #1-#6.

FIG. 5 is a view of the external mixer of the present invention taken perpendicularly to and along the axis of the mixer assembly shown in FIG. 4, and also depicts how the lobes disperse and break up the hot gas/air mixture. FIGS. 5-1 through 5-5 illustrate the areas incorporated by the lobes at their respective cross sections #1-#5. The cross-sections, as portrayed or positioned on the interior surfaces of the lobes, define interior mixer areas within their respective planes, respectively of 1,100 square inches (7,097 square centimeters) at plane #1 (FIG. 5-1), 1,110 square inches (7,162 square centimeters) at plane #2 (FIG. 5-2), 1,120 square inches (7,226 square centimeters) at plane #3 (FIG. 5-3), 1,154 square inches (7,445 square centimeters) at plane #4 (FIG. 5-4), and 1,223 square inches (7,891 square centimeters) at plane #5 (FIG. 5-5) which extends into plane 6 for attachment to the existing Pratt & Whitney JT8D-217/219 Series engine.

FIG. 6 is a side view, taken 90° with respect to the mixer shown in FIG. 5, of that mixer and its four undulating cross-sections and fifth circular cross section along planes #1-#5. The circular configuration of the lobes at plane #5 extends generally cylindrically with the same general diameter to its end at plane #6.

FIG. 7 is an enlarged view of a superimposition of the lobes and the same previously illustrated four undulating cross sections and fifth circular cross section as shown in FIGS. 4-6.

FIG. 8 is a view of the lobe shown in FIG. 7 looking down upon the apex of the lobe, in which the several cross sections indicate the varying curvature of the lobe as its extends along the mixer axis through cross sections or planes #1-#6.

FIG. 9 is a side view of the lobe shown in FIGS. 4-8 and illustrates the several lobe curvatures as it extends along the mixer axis, with specific reference to planes 1-6 with its attaching end to the nozzle or tailpipe.

FIG. 10 depicts the contour lines of a lobe between its planes #1-#6, as viewed looking down upon the lobe.

FIG. 11 is a view of a specific one of the section curvatures shown in FIG. 9 along with hardware for its attachment to the nozzle or tailpipe.

FIG. 12 is a schematic drawing, not to scale, of an engine nozzle assembly and modified STANG fairings for accommodating the jet nozzle mixer embodied in the present invention.

FIG. 13 is a perspective view of one of the STANG fairings as modified to accommodate the mixer of the present invention.

FIG. 14 is a graph attesting to the improvement in net thrust versus engine pressure ratio in a Pratt & Whitney JT8D-217/219 Series engine when use of the second stage external mixer of the present invention is compared to that of a standard nozzle, in which the engine pressure ratio is defined as the measure of engine exhaust pressure divided by ambient pressure.

FIG. 15 is a graph demonstrating the improvement in TSFC (thrust specific fuel consumption) versus thrust in a Pratt & Whitney JT8D-217/219 Series engine when use of the second stage external mixer of the present invention is compared to that of a standard nozzle.

FIG. 16 is a graph of preliminary flight test data of a McDonnell-Douglas MD-80 aircraft as evidence of the improvement in fuel consumption in terms of NAMPP (nautical air miles per pound of fuel) versus mach in a Pratt & Whitney JT8D-217/219 Series engine when use of the second stage external mixer of the present invention is compared to that of a standard nozzle.

FIG. 17 depicts a perspective view an additional preferred embodiment wherein the lobes assembled to form the external mixer assembly depicted in FIG. 4 include an adjustable rod spacer assembly adapted for engagement with the sidewalls forming each of the lobes to adjust the distance between the sidewalls and the resulting area of the formed chutes.

FIG. 18 depicts an end view showing a plurality of engaged lobes used to form the external mixer assembly and showing a rod spacer assembly engaged with the sidewalls forming the lobe. The rod spacer assembly may be adjusted to laterality translate its distal ends toward or away from each other thereby providing means for adjustment of the area of the formed chute.

FIG. 19 is an exploded view of the rod spacer assembly which is having distal ends adapted to engage with apertures formed in the sidewalls defining the chute of the lobes assembled to yield the external mixer assembly.

FIG. 20 is a partial perspective, 60 degree sectional view of an engine with a tailcone mixer in accordance with another embodiment of the invention and with the 60 degree section of the outer duct shown with a partial cut-away view.

FIG. 21 is a side view of the 60 degree sectional view illustrated in FIG. 20.

FIG. 22 is a rear view of the engine illustrated in FIG. 20 with the tailcone mixer as viewed along line 22-22 in FIG. 21.

FIG. 23 is a rear view of the engine illustrated in FIG. 20 with the tailcone mixer as viewed along line 23-23 in FIG. 21.

FIG. 24 is a perspective view of the tailcone mixer and the fan duct mixer of the engine illustrated in FIG. 20.

FIG. 25 is a cross-sectional view taken along line 25-25 in FIG. 24.

FIG. 26 is a cross-sectional view similar to FIG. 25, but with the tailcone mixer illustrated in isolation.

FIG. 27 is a side elevational view of a lobe.

FIG. 28 is a front elevational view of the lobe of FIG. 27 as viewed from the direction indicated by plane 28-28 in FIG. 27.

FIG. 29 is a rear elevational view of the lobe of FIG. 27 as viewed from the direction indicated by plane 29-29 in FIG. 27.

FIG. 30 is a cross-sectional view similar to FIG. 25, but illustrating yet another embodiment of a tailcone mixer in accordance with the subject invention, including a tailcone mixer with a weighted bullet end and rod spacers.

FIG. 31 is a cross-sectional view similar to FIG. 25, but illustrating a further embodiment of a tailcone mixer in accordance with the subject invention, including fins attached directly to a tailcone that is otherwise configured similar to a conventional tailcone.

### DETAILED DESCRIPTION

Because the present invention was devised particularly with respect to the Pratt & Whitney JT8D-217/219 Series engine, the following discussion will be directed specifically thereto; however, it is to be understood that the present invention is equally relevant for use in other jet engines and, therefore, is not to be limited to a specific jet engine.

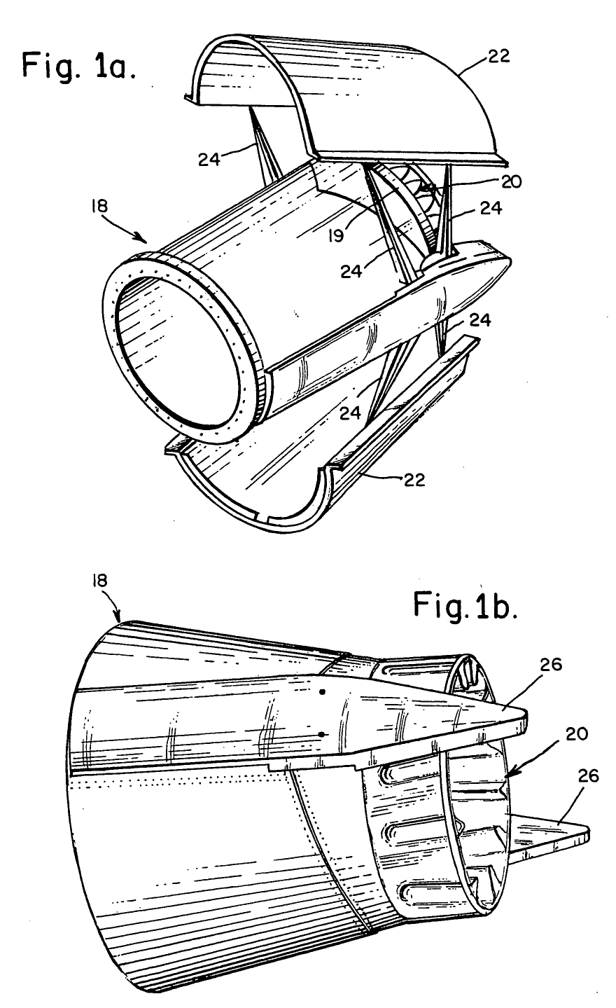

Accordingly, FIGS. 1a and 1b illustrate a nozzle assembly 18 relating to, for example, a Pratt & Whitney JT8-217/219 Series jet engine to which a jet nozzle mixer 20 as embraced by the present invention is attached at its exhaust terminus 19. Assembly 18 also supports a thrust reverser having a pair of thrust reverser buckets 22. The attachment of the thrust reverser buckets to assembly 20 is effected by bars 24 which are pivotally linked to a pair of diametrically opposed mechanisms housed within fairings 26, one of which is shown in FIG. 1. The fairings are secured at opposite sides of the assembly. The thrust reversers and the linking bars are of conventional design and are unmodified when coupled with the present invention. The fairings are also of conventional design, but a part of the structure covered thereby is slightly modified as will be explained below with respect to FIGS. 12 and 13.

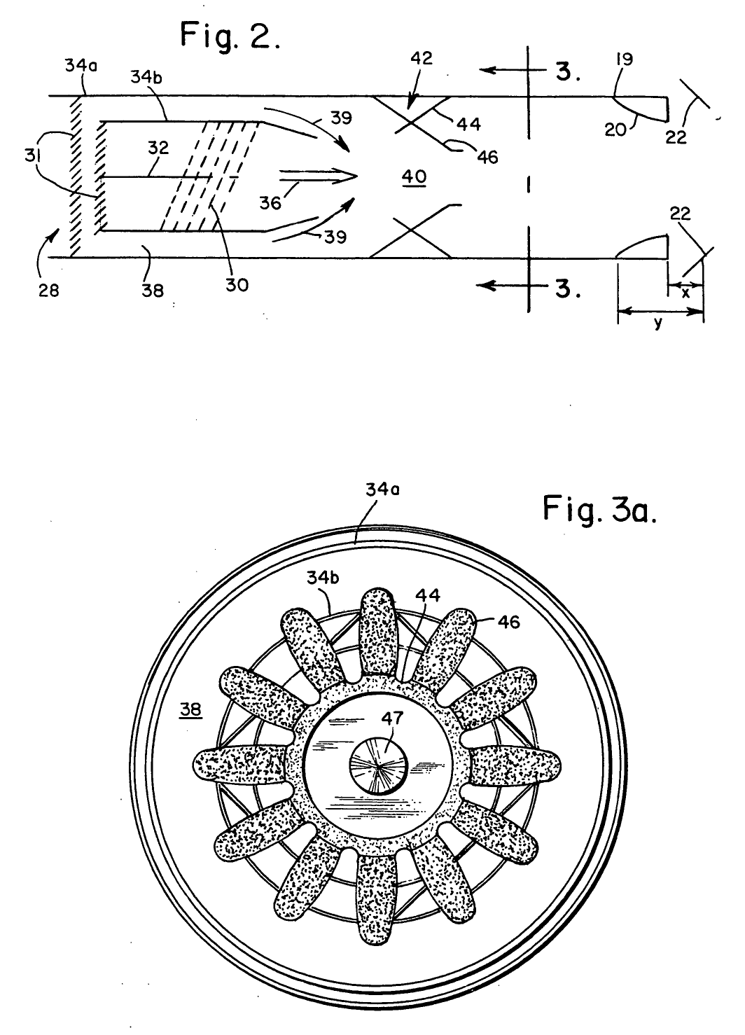

As shown also in FIG. 2, mixer 20, because of its added axial length, is positioned closer to thrust reverser buckets 22 when they are deployed as brakes. Such closer positioning is demonstrated by the different lengths “x” and “y” of FIG. 2. The ameliorative result of such closer positioning permits the buckets to capture a greater portion of the exhaust for braking purposes than previously obtainable. However, it is important that mixer 20 not be located too close to buckets 22 so that the flow of the redirected exhaust gases are not adversely affected and that the doors, linkages and the mixer are not deleteriously stressed.

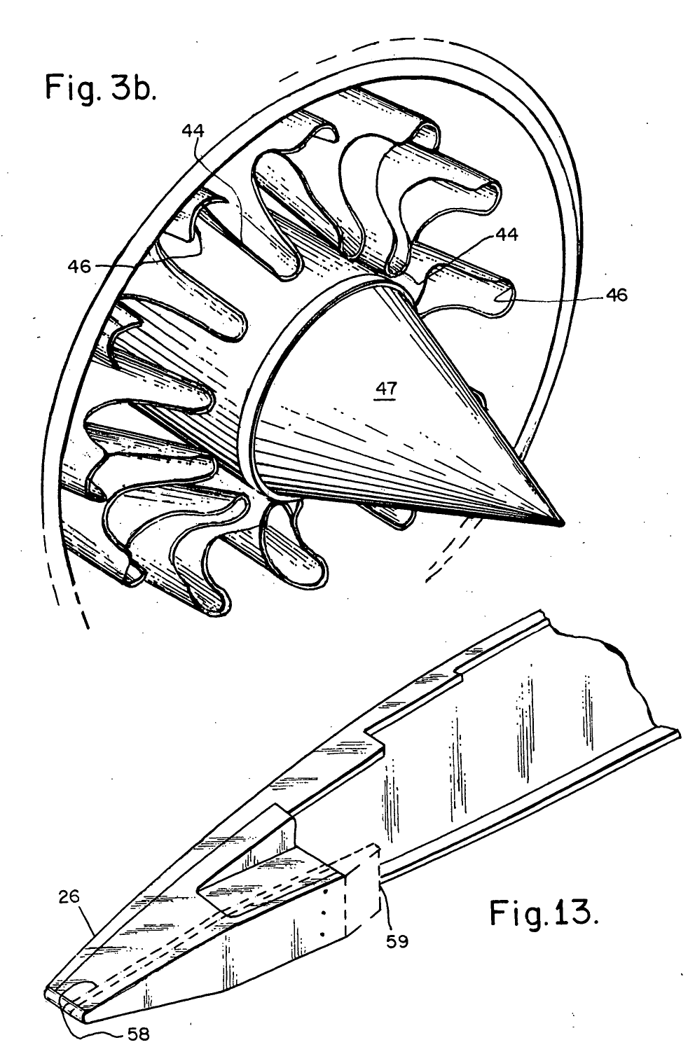

The internal arrangement of nozzle assembly 18 as secured to a jet engine is depicted in FIGS. 2, 3a and 3b. An engine 28 includes turbine blades 30 and compressor or fan blades 31 joined together on a common shaft 32 within a two-part housing 34a and 34b. For convenience, the burners preceding turbine blades 30 are not shown. Hot exhaust gases exit from the turbine blades as a core 36. A bypass or fan duct 38 surrounds housing 34b for affording passage of cooling air, as denoted by arrow-headed lines 39, from the ambient exterior to first stage or internal jet nozzle mixer 42 of the engine. Core 36 of hot gases is disposed to be mixed with the cooling air within a first stage mixing chamber 40 by use of first stage jet nozzle mixer 42 positioned therein. As best seen in FIGS. 2, 3a and 3b, first stage internal jet nozzle mixer 42 includes two sets of vanes 44 and 46 which are respectively inwardly and outwardly inclined to direct and mix together respectively the cooling air and the hot gases in chamber 40. Vanes 44 and 46 are positioned around a core terminating in a cone 47. As stated above, consistent with the Pratt & Whitney JT8D-217/219 Series jet engine design, the total of inwardly directed cooling air vanes 44 and outwardly directed hot gas vanes 46 respectively number twelve each. This resulting admixture divides core 36 into a smaller cooler central core and twelve surrounding small cores 11 of mixed hot gases and cooling air of different velocities which, nevertheless, are still extremely hot and produce an unacceptably high noise level. These smaller central and surrounding cores pass towards terminus 19 of the nozzle assembly for second stage mixing and cooling by second stage external jet nozzle mixer 20 of the present invention.

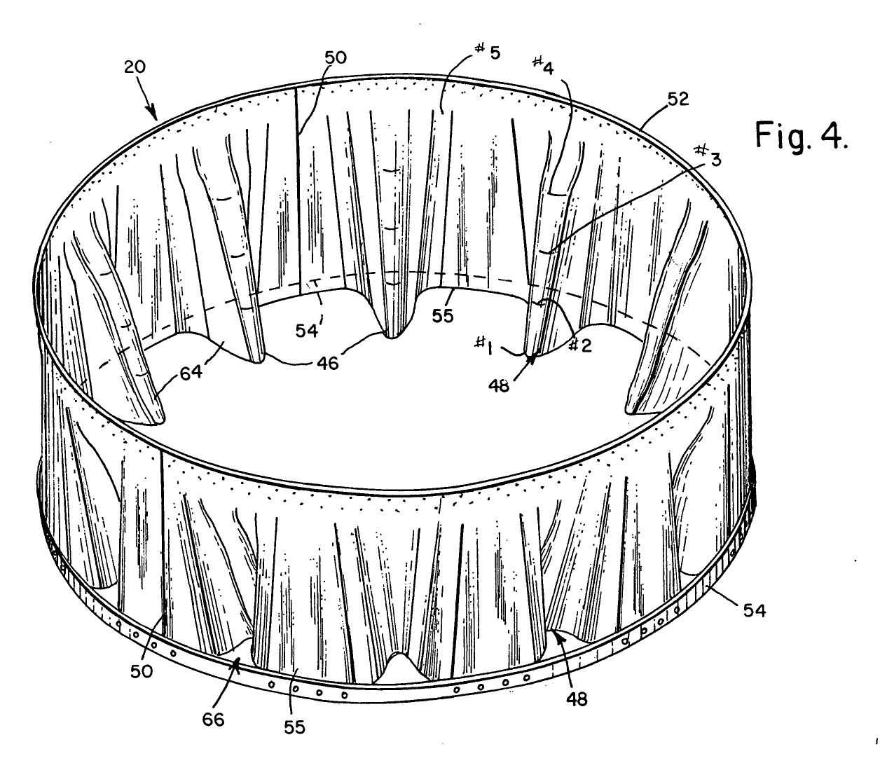

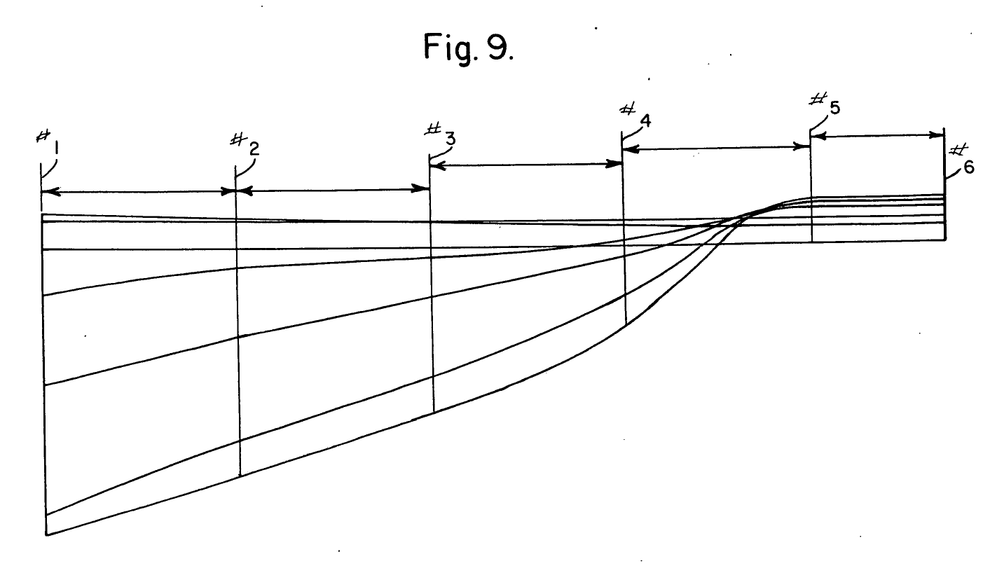

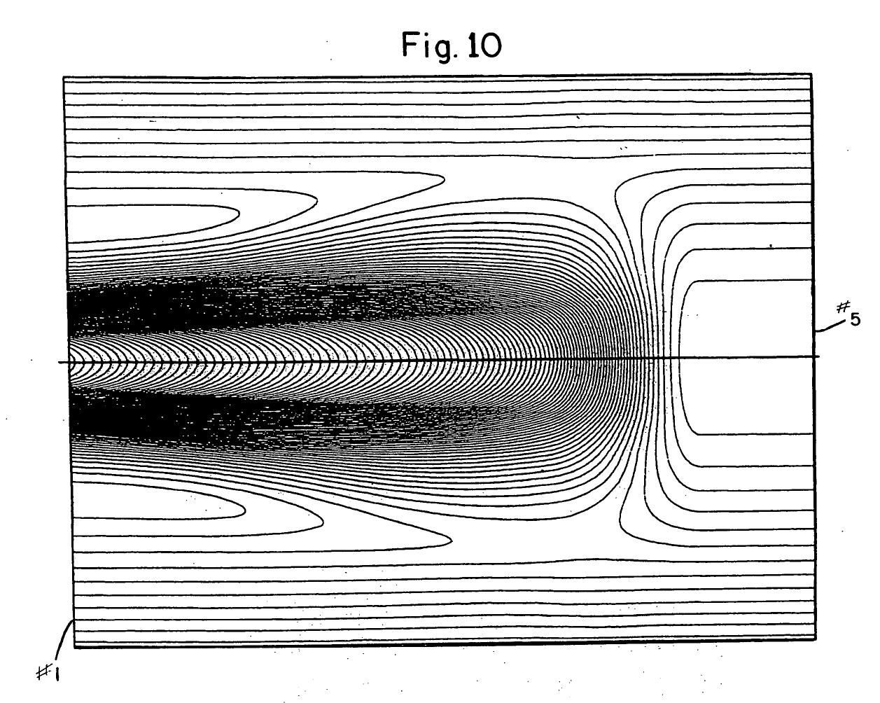

Second stage external jet nozzle mixer 20 and its component parts is illustrated in FIGS. 4-11. Mixer 20 includes twelve identical lobes 48 to equal in number the twelve cooling air vanes and the twelve hot gas vanes, and the twelve smaller hot gas cores of the internal mixer. For ease of manufacture, twelve sections, each including a lobe, is fabricated and the sections on either side of the lobes are welded together, such as identified by weld lines 50. Combined, the lobes extend from a circular section through a plurality of increasingly undulating portions, such as exemplified by cross sections #1-#6. The transition from a round configuration at cross-section #5 to the scalloped or undulated configuration at cross-section #1 is a very smooth complex curve and, consequently, minimizes airflow distortion and drag and maximizes the mixing of the hot gases with neighboring air and thereby to reduce noise. This is achieved by using synchronized cross-sections and a plurality of weighted and blending splines between the cross-sections. Such a design is provided using state-of-the-art CAD software.

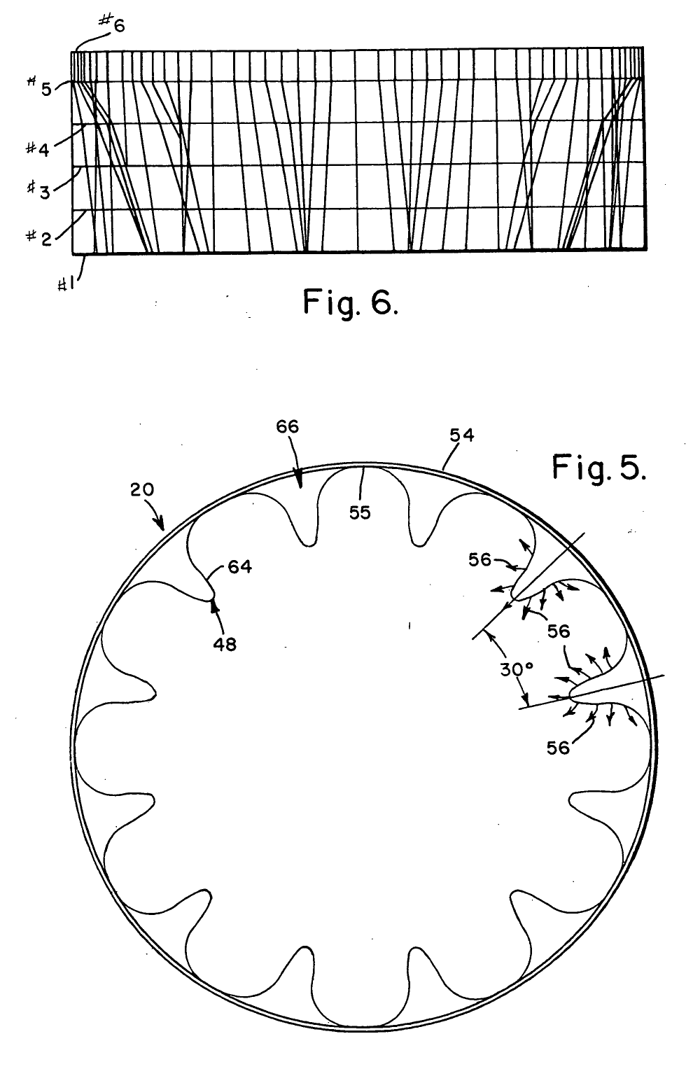

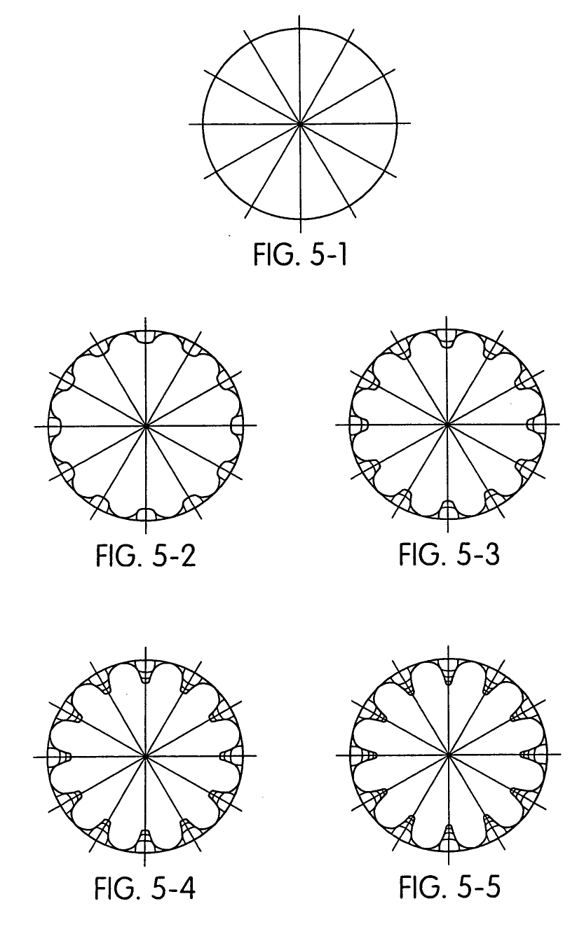

As stated above, the cross-sections, as portrayed on the interior surfaces of the lobes and depicted by shading in FIGS. 5-1 through 5-5, delimit interior mixer areas within the planes defined by the cross sections, respectively of 1,100 square inches (7,097 square centimeters) at plane #1 (FIG. 5-1), 1,110 square inches (7,162 square centimeters) at plane #2 (FIG. 5-2), 1,120 square inches (7,226 square centimeters) at plane #3 (FIG. 5-4), 1,154 square inches (7,445 square centimeters) at plane #4 (FIG. 5-4), and 1,223 square inches (7,891 square centimeters) at plane #5 (FIG. 5-5). The cross-sectional areas from plane #5 to plane #1 decreases arithmetically, about 5%, 2.5%, 1.25%, etc.

The section extending between cross-sections #5 and #6 is an extension from the section adjacent cross section #5 and is used to affix mixer 20 to the nozzle terminating the Pratt & Whitney JT8-217/219 Series engine, and has an equivalent 1,223 square inch (7,891 square centimeter) area. An annular reinforcing support band 52 (see particularly FIG. 11) joins the lobes at their circularly shaped section adjacent cross-section #5, while a band ring 54 is joined to lobes 48 at their base sections 55 at their greatest undulation at cross-section #1.

FIG. 11 also illustrates the attachment of mixer 20 to nozzle assembly or tailpipe 18. Specifically, the mixer is secured to terminus 19 of the nozzle assembly and to a doubler ring 70. Both terminus 19 and the doubler ring are angled outwardly and, compared to prior nozzle assemblies, are shorter by approximately 5 inches.

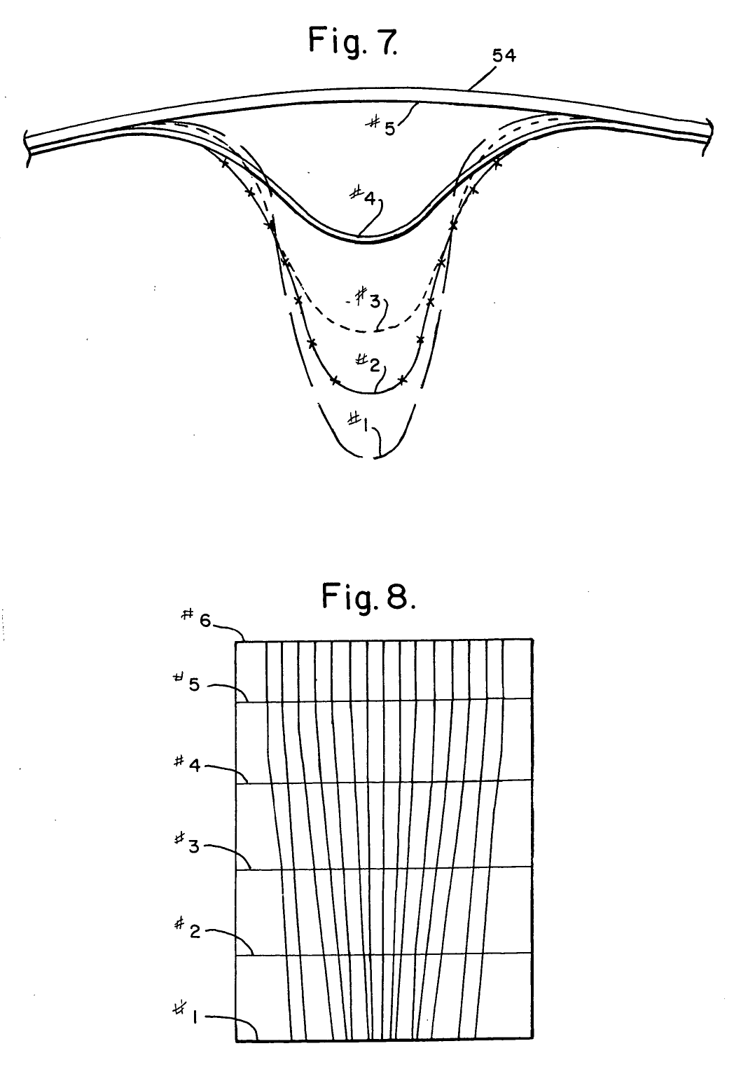

As shown, for example in FIGS. 7 and 11, the interior surfaces of the lobes force the impinging hot gas bypass cooling air mixture from internal mixer 42 in all directions towards the interior of internal mixer 20, that is, essentially 45° to 60° as illustrated by multiple arrow headed lines 56 in FIG. 5, to effect a vigorous mixing of the gases. At the same time, additional ambient cooling air is forced from the exterior surfaces of the lobes to mix further with the internally mixed gases. These actions cause the smaller gas cores from internal mixer 42 to break into myriad forms which are both cooler and considerably noise attenuated. In part, the internal contours of the lobes act as flutes or channels 64 to produce a similar aerodynamic action as the skins of the airplane wings to produce a lifting effect. This lifting effect causes the primary hot and cold flows to mix before entering the nozzle. The external contours of the lobes, which act as chutes 66, are designed to act as a multitude of venturis, and thus to accelerate the cooler secondary flow of ambient air. This arrangement effectively forms an injector to force the cooler ambient secondary flow into the previously mixed primary flow as it exits the nozzle. This action further reduces the noise level.

In addition, dimples 72 are formed on both sides of band 54 of the external mixer and act as vortex generators to prevent the mixed gas flow from attaching to band 54 and thereby to enhance the mixing action.

This afore-mentioned acceleration also helps to increase the efficiency of the fuel-air burning in the engine. By producing an increased flow, the exhaust gases are more rapidly exhausted from the engine and thereby the need for the engine and its bypass compressor to expend energy in moving these gases is alleviated.

In addition, the lobes are elliptically shaped, being proportional to a 10×2.5 ellipse, plus or minus 2 inches (5 centimeters) major axis, and plus or minus 0.5 inch (1.3 centimeter) minor axis. These curved sides help resist distortion caused by the exhaust gas pressure.

Because mixer 20, such as illustrated in FIGS. 4, 5, et seq., has a 1,065 sq. inch to 1,100 square inch (6,089 to 7,097 square centimeters) area encompassed by the lobes at plane #1 and a 1,223 square inch (7,891 square centimeters) area at plane #5, where the mixer is joined to nozzle assembly 18, it is possible to use the mixer without any modification of thrust reversers 22. As a result, it is necessary only to slightly reconfigure the structure covered by fairings 26. Such reconfiguration is depicted in FIGS. 12 and 13, and is effected by removing only a small portion from each of such structure, specifically that portion indicated by parallel dashed lines 58. Further, a tongue 59 is also removed.

The following points, although not exclusive, may be advanced in summary of the present invention.

A. As an important design parameter, the mixer has as short a length as is possible, e.g., 12 inches ±3 inches (30.45 cm ±8 cm). The lobe shape starts with a circular or rounded configuration at 39.7 inches (101 centimeters) and terminates with a scalloped or undulated configuration at the same diameter (39.7 inches or 101 centimeters) and an area of 1,065 sq. inches to 1,100 sq. inches (6,089 to 7,097 centimeters), which matches the existing tailpipe area. By keeping the mixer short, it will not interfere with the existing thrust reverser doors at the end of the tailpipe.

B. The mixer is designed so that it can be attached to the existing tailpipe with minimum impact on exiting components, such as the thrust reverser, thrust reverser doors, stang fairings, outer fairings.

C. The mixer has elliptically shaped lobes whose shapes are proportional to a 10×2.5 ellipse (plus or minus 2 inch major axis, and plus or minus 0.5 inch minor axis). These curved sides help to resist distortion caused by exhaust gas pressure.

D. The transition in the lobes from a round to a scalloped shape forms a very smooth curve in order to minimize airflow distortion and drag and to maximize the mixing of the hot gases with neighboring air. This is achieved by using six synchronized cross-sections and many weighted and blending splines between the cross-sections. The design was achieved using state-of-the-art CAD software, Surfcam, from Surfware, Inc.

E. The cross sectional area of the mixer, taken along its axis, decreases arithmetically, about 5%, 2.5%, 1.25%, etc., until its terminus is reached.

F. Rather than simply splitting the air flow, the mixer inner lobe surfaces ramps the exhaust gases inward and, at the same time, the outer surface draws outside air into the mixer using a type of NACA duct (airfoil air scoop) so that, when the hot gases and the cooling air is mixed, the exhaust noise is reduced.

G. The contour lines of the lobed surfaces form a uniform initial slope, which is desirable to ensure even pressure as the exhaust gases are redirected inward.

H. Testing of the final lobe shape design with models ensured that the lobes would be formed with relative ease from a flat sheet, and with minimum distortion or strain which would be otherwise caused by material stretching and compressing as the flat sheet is forced into the desired configuration. Such ease of formation is amenable to selection of the preferred material which comprises an aerospace alloy, Inconel 625, a difficult material to work.

Twelve lobes are used to match the existing twelve vanes in the engine that swirl and spin the exhaust gases as they leave the engine. The twelve “hot spots” inside the tailpipe, which are produced by the existing vanes, are broken up by the twelve lobes of the present invention, thereby minimizing any undesirable hot spots.

J. The lobe shape forms a complex compound surface, with as large as possible employ of radii used at all locations so as to minimize drag and to allow for the smoothest possible gas flow redirection.

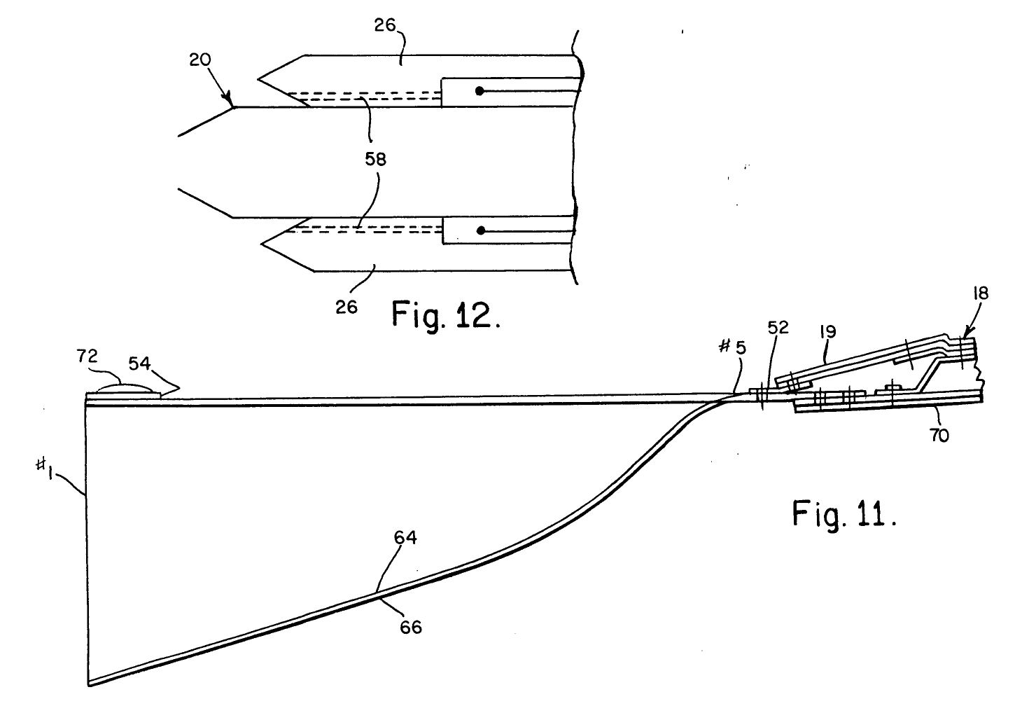

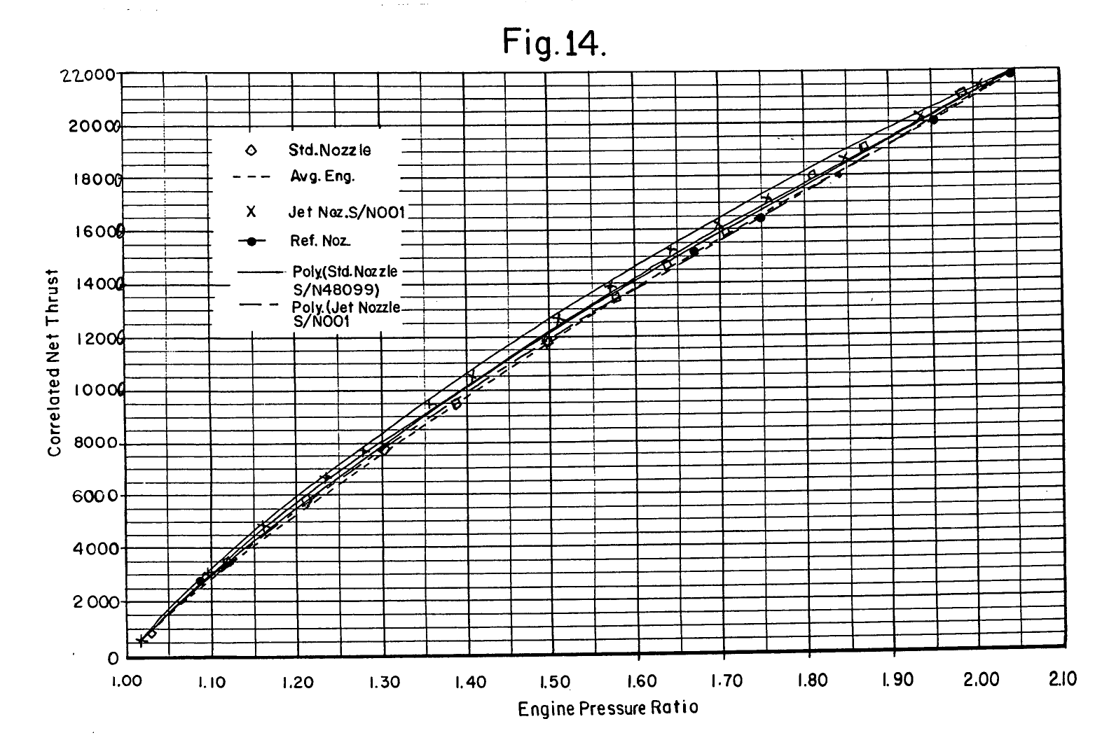

Preliminary testing of the present invention, as used in a Pratt & Whitney JT8D-217/219 Series jet engine, has disclosed decided improvements in performance as compared to conventional technology. Such data, as shown in FIGS. 14-16, are based upon present testing. It is therefore to be understood that final test results may evidence different data. Notwithstanding, as shown in these graphical representations of preliminary test data, the external or second stage mixer of the present invention demonstrates improved performance over that obtainable with conventional systems.

FIG. 14 discloses that, based upon a reasonable match for all engine parameters, such as engine revolutions per minute (rpm), exhaust gas temperature (EGT) and fuel pump data, the present invention demonstrates an increase in thrust at the mid range of engine pressure ratio (EPR), that is, engine exhaust pressure divided by ambient pressure. These tests were conducted by use of the external or second stage mixer of the present invention as compared to use of a standard nozzle (Serial Number 48099 as detailed in a United Technologies Corporation (UTC) document for its Pratt & Whitney engines, entitled “JT8D-209, -217, -217A, -217C, -219, TURBOFAN ENGINES ENGINE MANUAL PART NO. 773128” bearing an initial issue date of Jul. 1, 1979 and revised Nov. 15, 2001.

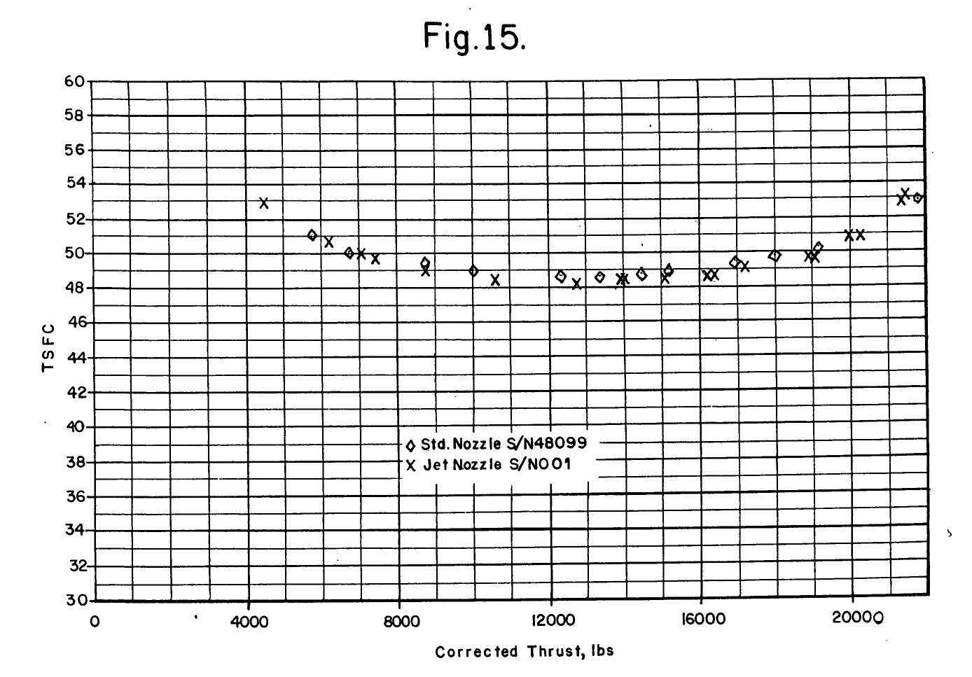

FIG. 15 reveals that the present invention, within a mid thrust range of 7,000 to 15,000 pounds of thrust, improves upon the TFC (specific fuel consumption) by a factor of approximately 2% to 3%. The following example is given to demonstrate the economic benefits obtained by assuming a 2% increase in fuel consumption. An engine average fuel burn of 7,000 pounds of fuel per hour converts into an approximate consumption of 1,000 gallons per hour of fuel. Based upon an assumed yearly flight usage of a McDonnell-Douglas MD-80 aircraft of about 2,000 hours per year, the aircraft consumes about 2,000,000 gallons of fuel per year. At a cost of $1.00 per gallon, the annual fuel cost for such an aircraft would be $2,000,000. Therefore, for a 2% improvement in fuel consumption as provided by the present invention, the saving would amount to $40,000 per aircraft.

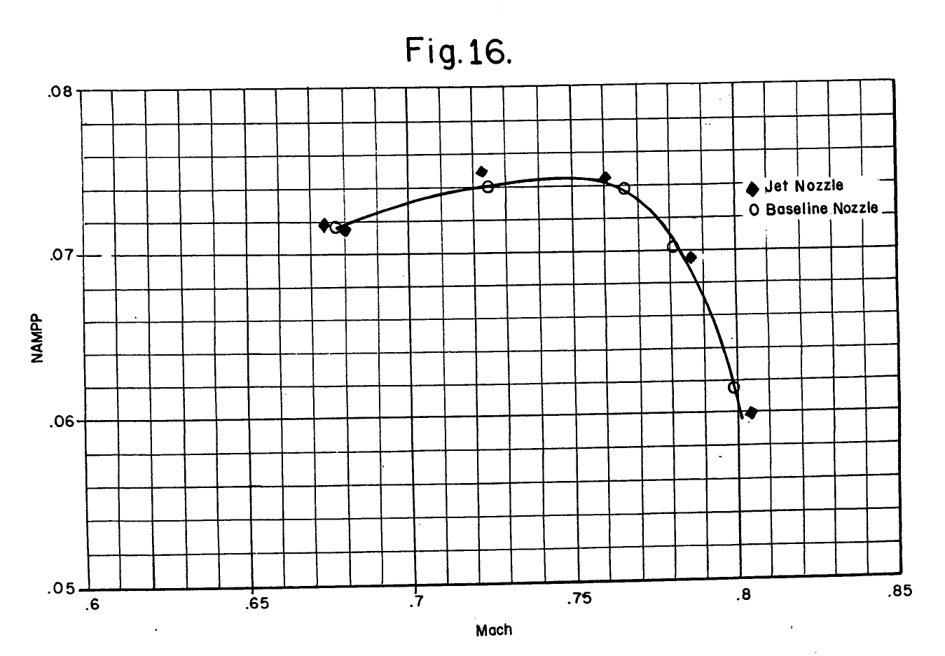

FIG. 16 compares the improvement in nautical air miles per pound of fuel (NAMPP) versus mach number for a McDonnell-Douglas MD-80 aircraft through use vis-a-vis non-use of the present invention. Here, preliminary flight data shows an increased NAMPP of the “JET nozzle” over all points on the curve when employing the present invention over its non-use “baseline nozzle.”

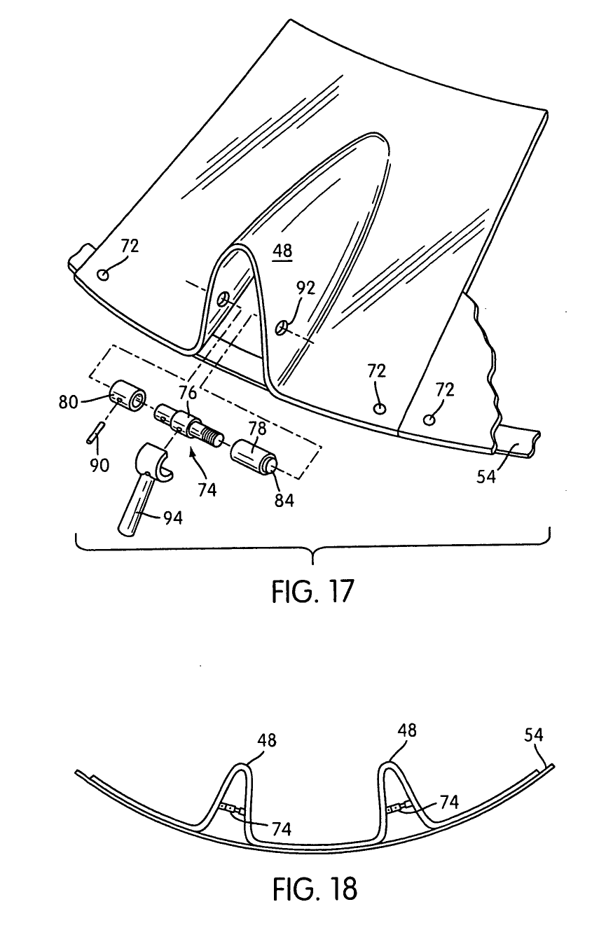

FIG. 17 depicts a perspective view an additional preferred embodiment of the disclosed device wherein the plurality of lobes 48 are assembled to form the jet nozzle mixer 20 with the band 54 engaged around the assembled lobes 48 at the terminus area of the second stage external jet nozzle mixer 20 to maintain heir shape and the total area of the terminus area defined by the undulating surface of the assembled lobes 48. This band 54 is attached around the external surface to maintain the size of the terminus when exhaust gasses are forced therethrough which exert and expanding force on the terminus area of the assembled lobes 48.

Since the intricate bends of the metal forming each lobe 48, determine the ultimate total area of the second stage mixer terminus, when the plurality of lobes 48 are assembled into a second stage external jet nozzle mixer 20, it is extremely important that the forming of the lobes 48 yield proper contiguous shape around the terminus area to yield the a total second stage mixer terminus to match that of the first stage, as noted above. This match is especially important in that the engine speed of the jet engine is directly impacted by the total area of the terminus area defined by the band encircled lobes 48. Every jet engine in use commercially has an FAA and manufactured determined engine RPM that must be maintained during operation of the engine. A second stage external jet nozzle mixer 20, which when attached, causes the jet engine to run at this approved RPM is said to achieve a match. A very slight change in the total area of the terminus area of the second stage external jet nozzle mixer 20, when engaged on the engine, can severely impact the engine RPM causing it to exceed or run under the manufacture and FAA required engine RPM speed. Consequently, it is exceedingly beneficial to form the second stage external jet nozzle 20 from a plurality of properly shaped lobes 48 which when banded at a determined torque or pressure exertion by the band 54, will yield a total area of the terminus area to achieve a match to the FAA and manufacturer requirements. However, just like different car engines may need carburetor adjustments to match the airflow to the idiosyncrasies of the engine, or the manufacturing tolerances of the carburetor, different second stage external jet nozzle mixers 20 may need adjustments in lobe size, shape, and radius to achieve this match and proper engine RPM when attached to the first stage or internal jet nozzle mixer 42 of the engine to which it is engaged. Further, manufacturing tolerances and slight differences in the size, shape, or radius of the individual lobes 48, when assembled into a second stage external jet nozzle mixer 20, and engaged at the proper torque specifications by the band 54, can add up to cause the formed second stage external jet nozzle mixer 20 which has an exit terminus area adjacent to the band 54 which is of improper size. This can cause the engine speed to exceed or underperform the narrow range of FAA and manufacturer specified RPM. Further, because the chutes 66 formed by the lobes 48 direct ambient air into the exhaust flow at the terminus area and thereby help attenuate noise, correct dimensioning of the lobe 48 to yield a properly shaped exterior surface forming the chute 66 is also important.

Conventionally, when such a mismatch occurs between the area of the terminus area causing improper engine RPM and/or noise outside of the specified range, the entire second stage external jet nozzle mixer 20 would have to be reengineered. In that process many man hours of engineering and manufacture are required at great expense. Further, tooling must be manufactured to form the lobes 48 at slightly different dimensional characteristics to hopefully yield the proper total terminus area when assembled and compressed by the band 54. Because of the many variables involved in calculating the terminus area on the assembled and banded second stage external jet nozzle mixers 20, it is exceedingly difficult to determine if the outcome of the reengineered device will yield the proper terminus area to yield the match in engine RPM to FAA and manufacturer specifications when it is finally attached. This trial and error manner of engineering and construction is done at great cost in time and money.

Consequently, this preferred embodiment of the disclosed device is especially useful as it provides a means to adjust the dimensional characteristics of the lobes 48 by changing the external contours of the lobes 48 which also act as chutes 66 of the assembled second stage external jet nozzle mixer 20, Employing this embodiment, not only may the total area of the terminus area be adjusted easily to achieve the desired engine speed match, it also allows provides a means of adjustment of the dimensional characteristics of the chutes which in turn provides a means to adjust noise attenuation. The provision of such adjustability allows each second stage external jet nozzle mixer 20 to be tuned to both correct any manufacturing anomalies that might have occurred in lobe dimensions as well as to match the individual second stage external jet nozzle mixer 20 to the engine and first stage mixer to which it is engaged to achieve an RPM match to the FAA and manufacturer specifications. No longer need the entire second stage external jet nozzle mixer 20 be reengineered and re manufactured at great cost in time and money if a mismatch occurs on the first installation and testing of the device.

Such means for adjustment of the total area of the terminus area is provided in this preferred embodiment through the inclusion a means for dimensional adjustment of the lobes 48 in the form of a means translate said two sides of each lobe 48 away from the lobe center axis. A very slight change in the dimension of the lobes 48, and thereafter engaging the band 54 thereover at the proper compression specification, thereby alters the total area of the terminus area. Because the total terminus area may be changed easily, achieving the FAA and manufacturer required match for proper engine RPM is achieved without any need for re engineering and re manufacturing.

Further, older second stage external jet nozzle mixers 20 which either lack this means for adjustment of the total area of the terminus area may be retrofitted with the means for dimensional adjustment of the lobes 48 and thereby provide the means to adjust the total terminus area. Or, second stage external jet nozzle mixers 20 which do have this means for terminus area adjustment but have fallen out of the specified range to achieve a match to proper RPM may be easily reset the proper terminus area to achieve the specified engine match by simply removing the band 54, changing the lobe dimensions, and recompressing the band 54.

The means to adjust the dimensional characteristics of the lobes 48 to thereby adjust the total area of the terminus area, in the current preferred embodiment is provided by a rod spacer assembly 74 engaged across each chute 66. Concurrently, adjusting this means to adjust lobe dimension to adjust the area of the terminus, also adjusts the size and consequently the area of each exit aperture of each chute 66 positioned at adjacent to the terminus of the second stage external jet nozzle mixer 20. Since adjustments to this chute exit aperture dimension will affect the amount, direction, and speed of ambient airflow therethrough, and the chutes 66 help attenuate noise from the engine, such adjustments also provide a means to adjust noise attenuation from the engine to which the second stage external jet nozzle mixer 20 is attached. In use therefor, the device may be used for either or both adjusting the terminus area to achieve proper engine speed match, or noise attenuation of the engine.

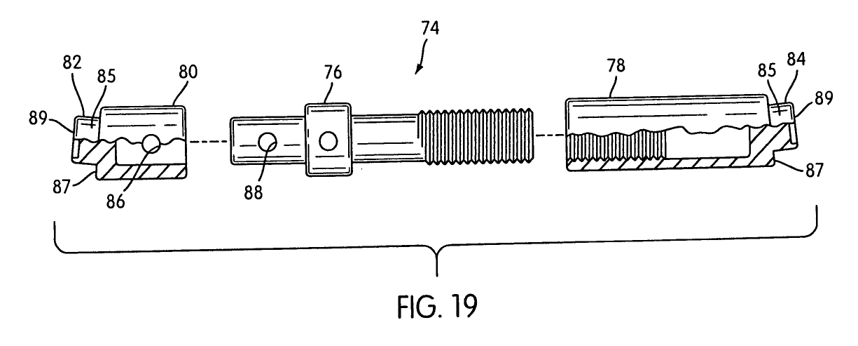

The means to adjust dimensional characteristics of the lobe is depicted rod spacer assembly 74 which is adapted at a first end 82 and second end 84 to engage with the two opposing walls forming the lobe 48. A current preferred means of engagement of the two ends of the rod spacer assembly 74 with the two opposing walls forming the lobe 48 features shoulders 85 formed on both ends of the rod spacer assembly 74 sized to cooperatively engage with lobe apertures 92 communicating into the walls forming each lobe 48. As best shown in FIG. 19, sloping the center axis of the shoulders 85 in relation to the center axis of the assembled rod spacer assembly 74 yields an angled base 87 which smoothly engages the angled surface of the chute 66 and angled end walls 89 which fill the area of the lobe apertures 92 and thereby provide a substantially smooth lobe surface on the channel side of the lobes 48.

Each rod spacer assembly 74 when engaged in the individual lobes 48, as can be seen in FIG. 18, in providing a means to adjust dimensional characteristics of the lobe 48 provides the means to adjust the total terminus area of the second stage external jet nozzle mixer 20 to achieve the desired match to the engine. As can be seen in FIG. 19, the first end 82 of the rod spacer assembly 74 is laterally translatable toward and away from the second end 84 by rotating the stud 76 in its threaded engagement with the barrel nut 78. When the stud 76 is rotated by a tool 94 adapted to engage the stud 74, it rotates freely on one end rotationally engaged in a barrel sleeve 80 and in a threaded engagement at the opposite end with the barrel nut 78. This rotation as can be discerned from FIG. 18. will cause the first end 82 to move either toward or away from the second end 84. When engaged in the lobe apertures 92 of the lobe 48, moving the first end 82 away from the second end 84 will in turn force the walls forming the lobe 48 outward slightly thereby increasing the total terminus area of the chute 66 while concurrently slightly decreasing the total of the second stage mixer terminus area formed by the total exterior surface area of the undulating lobes 48 in the assembled second stage external jet nozzle mixer 20. Since the lobe 48 is preformed, expanding the rod spacer assembly 74 compressibly engages it within the chute 66 of the lobe 48 holding it in place while concurrently adjusting the dimensional characteristics of the lobe 48.

Once rod spacer assembly 74 is so compressibly engaged to move the two walls away from the lobe center axis, rotation of the stud 76 in the opposite direction will cause the first end 82 to move toward the second end 84 and thereby cause corresponding decrease in the terminus area of the chute 66 while concurrently increasing the total terminus area of the second stage mixer 20. Once adjusted correctly, a locking pin 90 is engaged and the band 54 is engaged around the second stage external jet nozzle mixer 20 immediately adjacent to the terminus area to the proper tension. Currently that tension can be in a range between 150 and 350 pounds. Once the band 54 is so engaged, the total area of the terminus area is fixed. To achieve the perfect match for engine RPM the rod spacer assembly 74 provides a means to fine tune the area of each individual chute 66 and to fine tune the total area of the terminus area of the second stage external jet nozzle mixer 20. Each individual engine may be matched to each individual second stage external jet nozzle mixer 20 with great precision and with ease.

Since each chute 66 acts as a venturi accelerate the cooler secondary flow of ambient air into the previously mixed primary flow as it exits the nozzle, which in turn further reduces the noise levels, the ability to fine tune each chute 66 provides a means to adjust or attenuate the noise level exiting the jet engine. Further, since the rod spacer assembly 74 also provides a means to adjust the total terminus area of the second stage external jet nozzle mixer 20, this terminus area can be easily adjusted and matched to each individual engine on which it is mated. This give the user the ability to adjust this terminus area with great precision to a total area is consistent with that of the engine in question while concurrently making adjustments to each individual chute 66 to reduce noise levels if desirable. The inclusion of such rod spacer assemblies 74 thus yields heretofore unmatched precision in mating each second stage jet nozzle mixer 20 to the idiosyncrasies of each individual engine on which it is respectively mounted providing the user with the ability to adjust for noise, and for engine exhaust area to terminus exhaust area to yield better performance from each jet engine on which it is mounted.

As can be seen, the rod spacer assembly 74 might also be used as a retrofit to second stage external jet nozzle mixers which do not have such a device to provide for adjustment of the terminus area of the chutes 66 and the total terminus area defined by the exterior surface of the lobes 48. Once such a lacking second stage external jet nozzle mixer is removed and its band removed it would be ready for retrofit. A method of accomplishing this task would be to form a means to engage the two ends of a rod spacer assembly 74 in the chutes 66 of a second stage jet external jet nozzle mixer lacking a means to adjust lobe dimension to adjust the total terminus area. This currently would entail the placement of lobe apertures 92 in each lobe positioned to cooperatively engage the two ends of each rod spacer assembly, however other means to engage the ends could be used and are anticipated for all embodiments of this device. Next, an assembled but collapsed rod spacer assembly 74 would be placed in the appropriate chute 66 and expanded such that the two ends of the rod spacer assembly 74 engage with the two walls of the lobe 48. Finally, the distance between the two ends of the rod spacer assembly 74 would be translated to a position away from each other to change each of the lobe dimensions and expand the chute 66 areas and thereby tune the total terminus area of the second stage external jet nozzle mixer 20 to match the terminus area of the engine on which it is attached to yield the best engine performance and lowest noise level. The band would be reattached and tensioned to the proper force and the device reattached to the jet engine. This could be done to achieve the proper performance characteristics and noise attenuation on any jet engine currently using a second stage jet nozzle mixer 20 to reform the terminus to achieve the engine match.

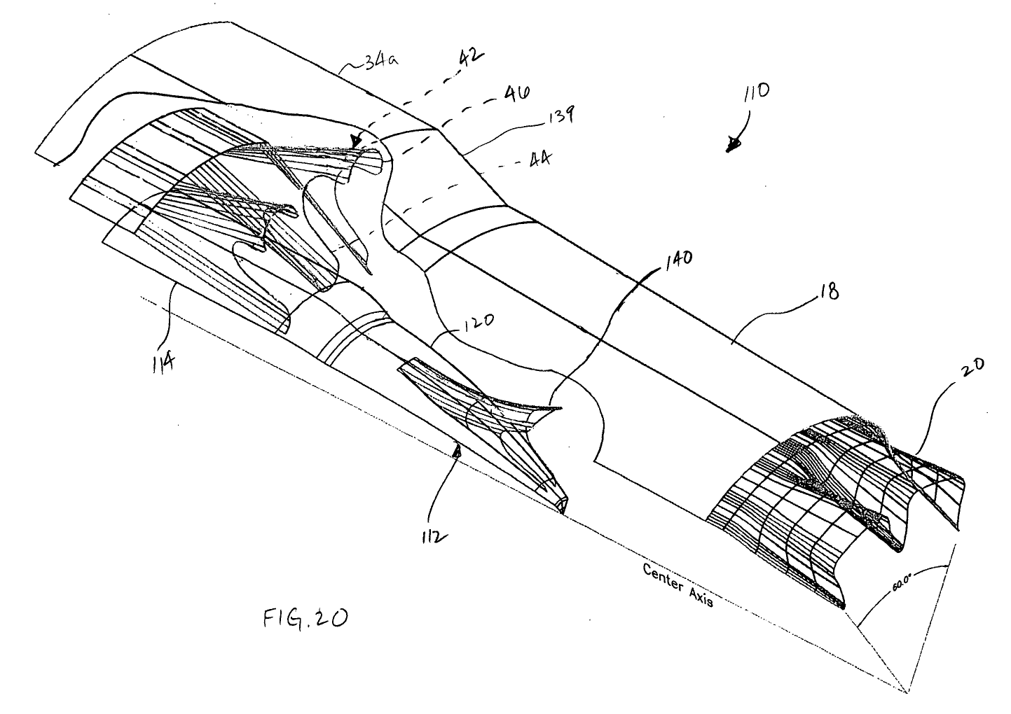

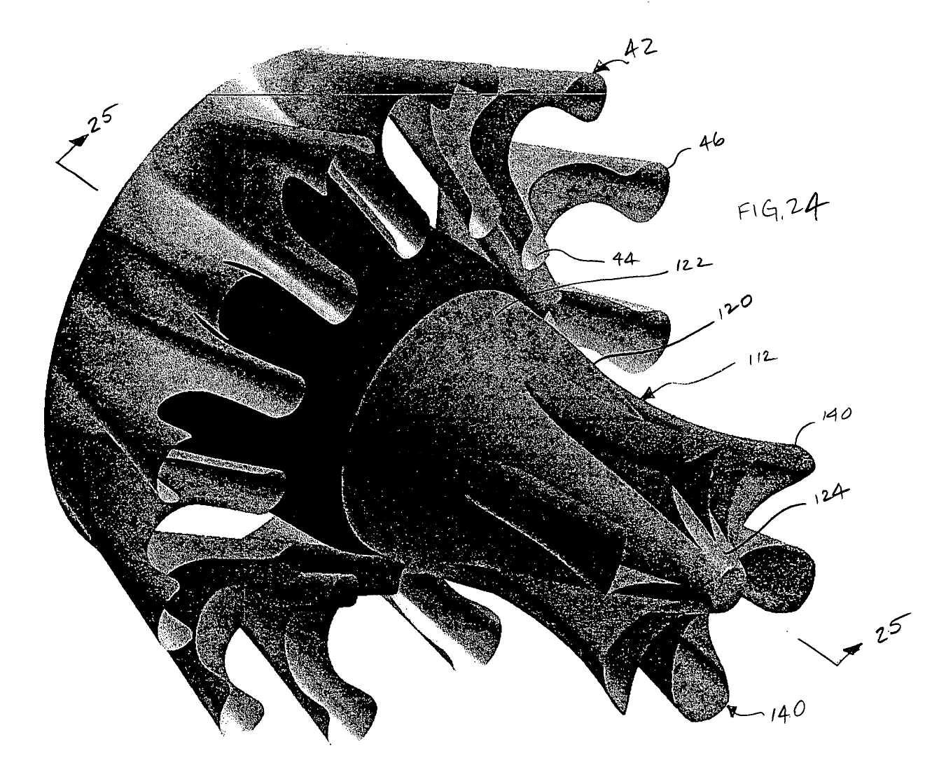

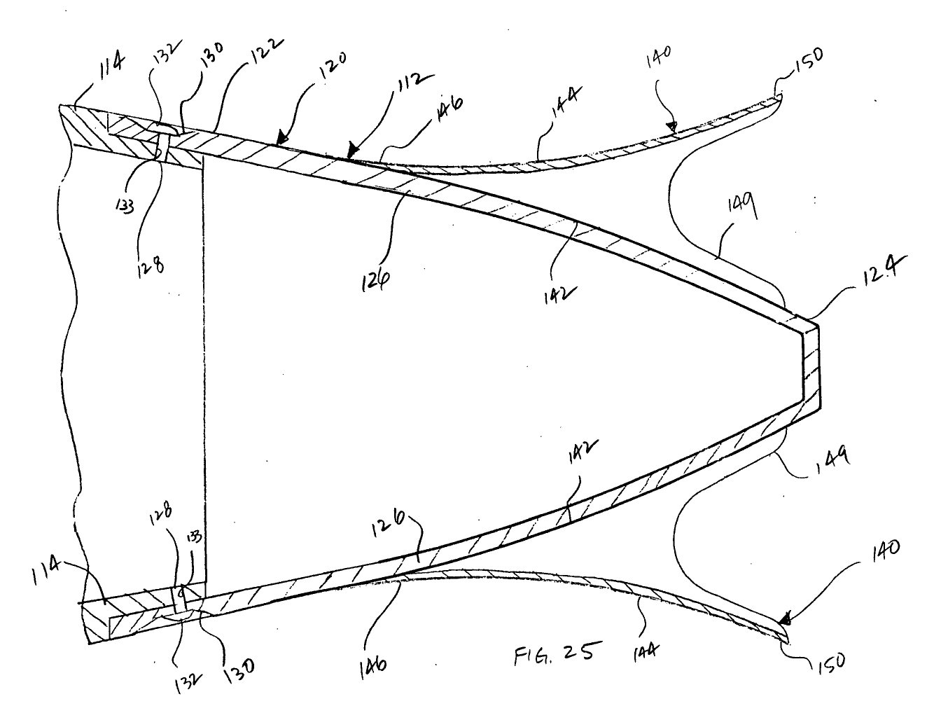

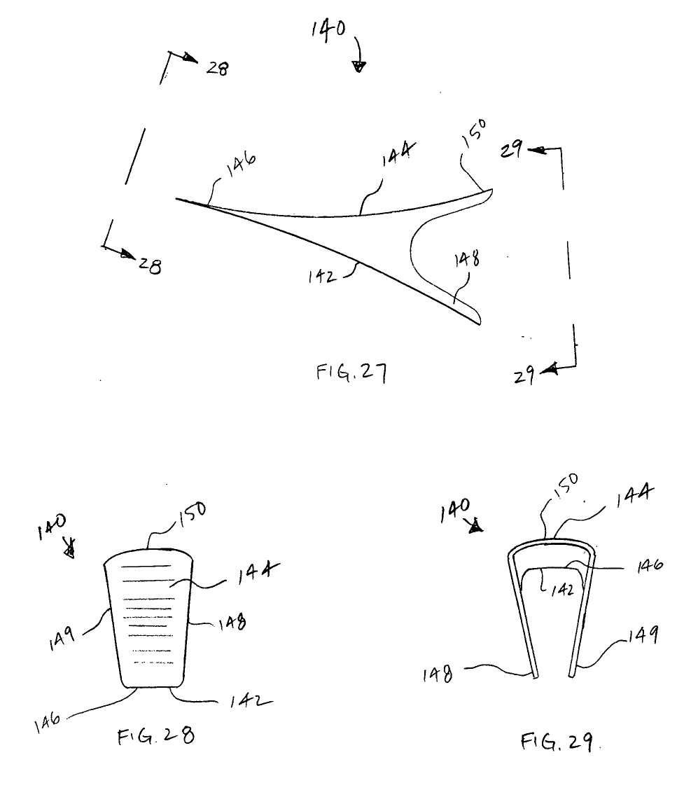

FIGS. 20-29 illustrated another embodiment of the subject application. That is, FIGS. 20-29 illustrate a jet engine 110 that is substantially similar to that disclosed above with respect to the various embodiments of FIGS. 1-19, but further including a tailcone mixer 112 that is attached to the inner duct 114 and that further mixes the exhaust from the first stage internal mixer 42, to further lower the temperature of the exhaust and further decrease the axial velocity of the exhaust, especially when compared to using merely a conventional tailcone 47 as seen in FIG. 3b.

As seen in FIG. 20, the tailcone mixer 112 may be used in combination with the external jet nozzle mixer 20 as described above and, thus, engine 110 includes all of the benefits of the external jet nozzle as set forth above, in addition to the benefits of the tailcone mixer 112. However, tailcone mixer 112 may be used without external jet nozzle mixer 20.

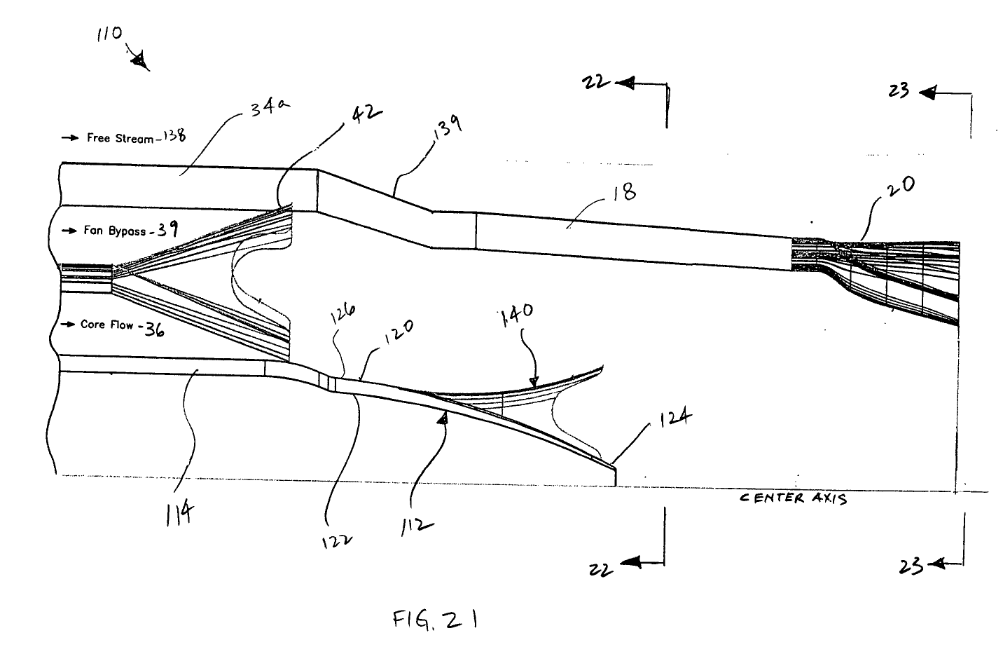

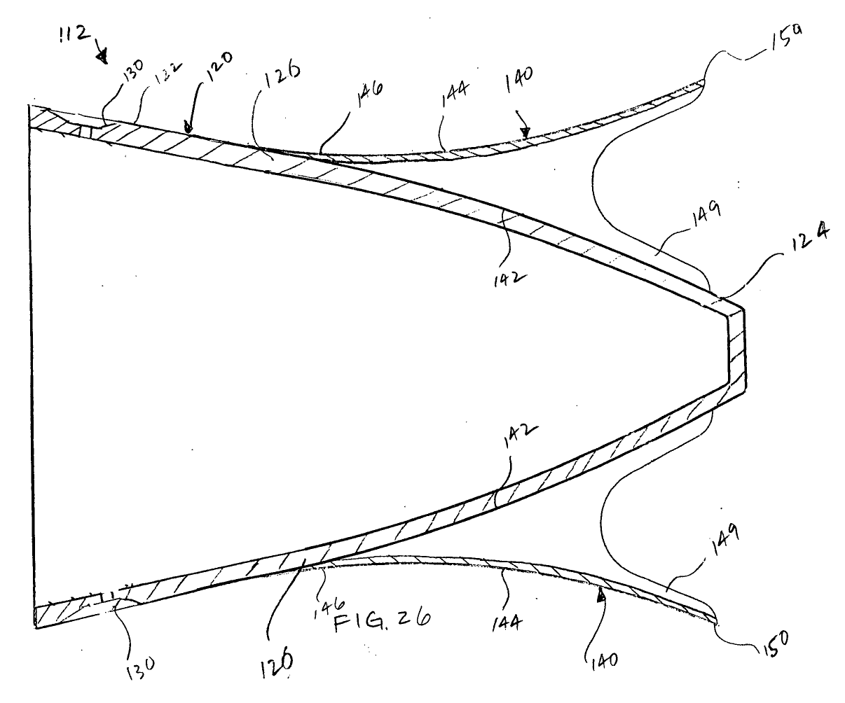

As best seen in FIGS. 26-29, tailcone mixer 112 includes a main body 120 that may be substantially hollow, having a wider forward end 122 and a more narrow rear end 124 and a mid-portion 126 extending between the forward end 122 and the rear end 124. The forward end 122 being structured and arranged for attachment to an inner duct case 114, while the rear end 124 is closed. The mid-portion 126 may have a sloping contour from the forward end 122 to the rear end 124. Preferably, at least a section of mid-portion 126 toward the rear end 124 has some curvature to accelerate the flow of air over the mid-portion 126 to a lower pressure. Also, the entire mid-portion 126 or just sections of the mid-portion 126 may be substantially straight, as desired as seen in the embodiment of FIG. 32. Although, FIG. 21 illustrates a slight depression 127 formed at the connection of the outer surfaces of the tailcone mixer and the inner duct 114, the precise contour of the main body 120 of the tailcone mixer 112 may be configured as deemed optimal. Further, the connection between the forward end 122 and the inner duct 114 may contain a slight depression 127 as illustrated, or may be substantially flush and smooth so that the connection and contour between the outer surfaces of the inner duct 114 and the tailcone mixer are substantially seemless.

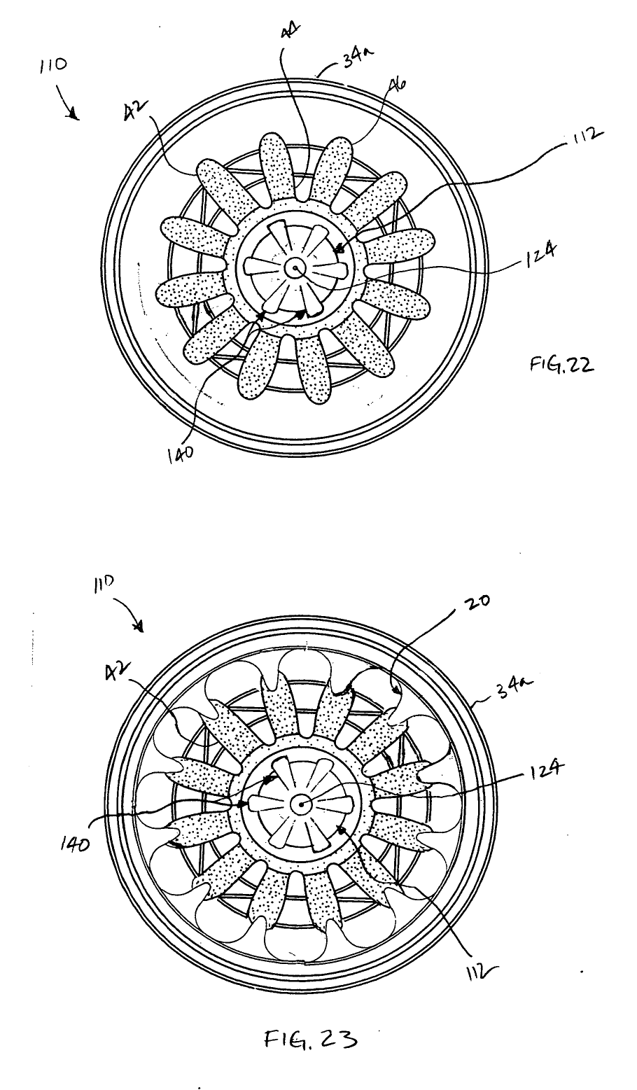

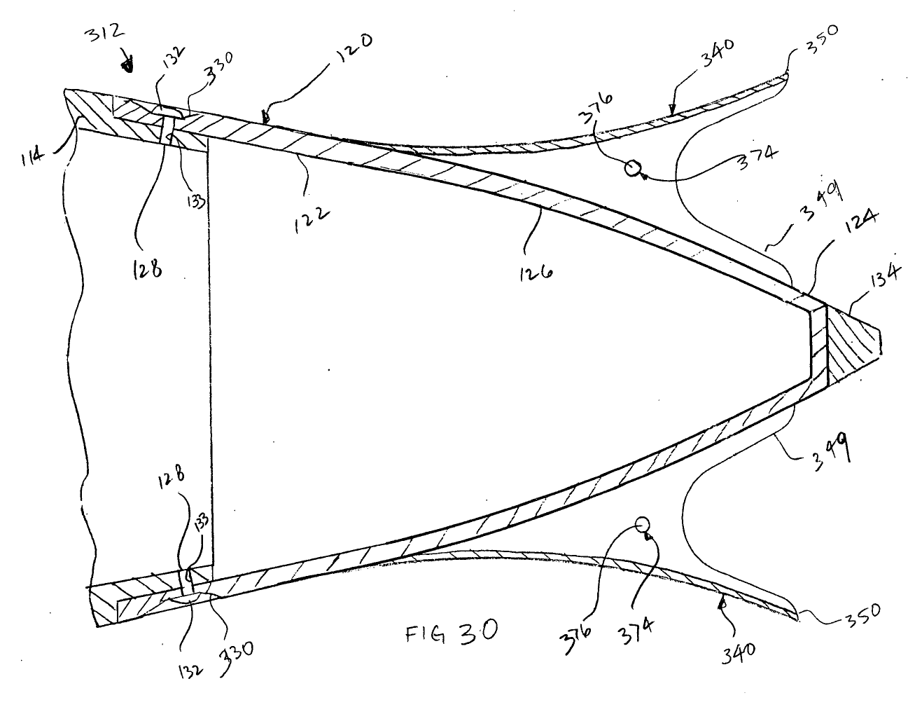

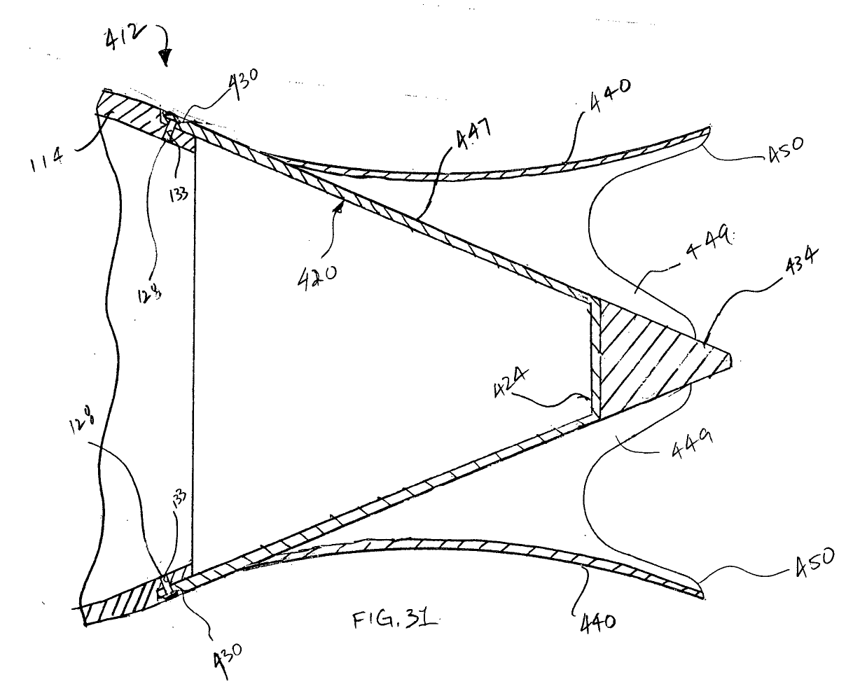

As best seen in FIGS. 22 and 23, the forward end 122 is substantially circular in transverse cross-section so that it can mate with the existing inner duct 114. The forward end 122 may be attached to the inner duct 114 in a variety of ways, but is illustrated as being attached by fasteners 128. The forward end 122 has a series of apertures 129 that open to a corresponding recess 130 so that the heads 132 of the fasteners 129 are recessed and out of the air flow over the inner duct 114 and the tailcone mixer 112. Any appropriate number of fasteners 129 may be employed. The rear end 124 may also be substantially circular in transverse cross-section as seen in FIGS. 22 and 23. A cone-shaped weight 134 may be rigidly secured to the rear end 124 as illustrated in the embodiment of FIG. 30.

In order to mix the exhaust from the first stage internal mixer 42, the main body 120 of the tailcone mixer 112 includes mixing devices such as a plurality of lobes 140, which are each rigidly secured to the mid-portion 126. As seen in FIGS. 22-24, the illustrated embodiment includes six lobes 140 that are evenly spaced from each other in a substantially circular configuration, while each is positioned at the same longitudinal position along the length of the main body 120. Thus, each lobe 140 is preferably substantially identical to each other lobe 140. The lobes 140 may be shaped and configured as desired to provide the optimal amount of mixing of the exhaust from the internal mixer 42 such as, for example, to decrease noise by decreasing the temperature and velocity of the exhaust.

In the illustrated embodiment, each of the lobes 140 has an inner section 142 and an outer section 144 that extend from a forward 146 section. The forward section 146 is adjacent the mid-portion 126 of the main body 120. The inner section 142 extends from the forward section 146 towards the rear end 124 of the main body 120 while substantially following the contour of the mid-portion 126 of the main body 120. The outer section 144 extends rearwardly from the forward section 146 and has a sloped contour that gradually diverges from the sloping contour of the mid-portion 126. Preferably, the sloped contour of the outer section 144 is curved, producing the illustrated deep scallop-shaped lobes 140.

Each of the lobes 140 has a generally U-shaped transverse cross-section with the inner section 142 including two inner legs 148 and 149 that may become narrow appendages that taper toward the rear end 124. Each of the inner legs 148 and 149 form a side of a lobe 140. The outer section 144 of each lobe 140 also includes an upper section 150 that may be arched and that connects the two inner legs 148 and 149. Each of the lobes 140 may be generally elliptically shaped as illustrated in the figures. Upper section 150 may be tapered, for example, in a manner similar to inner legs 148 and 149. Each of the lobes 140 may be an integrally-formed from a single piece of material as a one-piece element. One example of an appropriate materials is Inconel 625. Generally, the lobes 140 may be similar in structure to other lobes-type elements of other mixing devices such as the internal mixer 42 and the external jet nozzle mixer 20, except being shaped and configured for the purpose of mixing exhaust at the tailcone. Lobes 140 are preferably hollow between legs 148 and 149 and are rigidly secured to main body 120 in an appropriate manner, such as welding. The lobes 140 are preferably arranged on main body 120 as a plurality of evenly spaced lobes arranged around the main body 120. Preferably, the lobes 140 are positioned more toward the rear end 124 of the main body 120. The illustrated embodiment shows six, evenly spaced lobes 140, but other numbers of lobes may be used, as desired. Although, preferably, the lobes 140 are used in even numbers, such as 2, 4, 6, 8, etc. Also, the spacing between lobes can be selected as desired. The lobes 140 may also be integrally connected to one another in the form of a ring of lobes that is rigidly secured to the main body 120.

As illustrated in FIGS. 20 and 21, the tailcone mixer 112 may be used in combination with the external jet nozzle mixer 20. However, other configurations are possible, including use of the tailcone mixer 112 without the external jet nozzle mixer 20.

The attachment of tailcone mixer 112 may be accomplished in a variety of ways. For example, the existing tailcone 47 may be removed from the inner duct 114 by, for example, removing the attaching fasteners, and may be replaced with the tailcone mixer 112. The tailcone mixer 112 may be attached to the inner duct 114 using fasteners 128 and employing the same fastener openings 133 in the inner duct 114 used for attaching existing tailcone 47. Thus, the attachment of tailcone mixer 112 may be a retrofitting or a repair to an existing engine to replace existing tailcone 47 with a tailcone having mixing capabilities, such as tailcone mixer 112.

As seen in FIG. 21, in use, the free stream of ambient air 138 moves outside of the outer duct 34a, the tailpipe 18, and the transitional duct part 139 connecting the outer duct 34a and the tailpipe 18. Meanwhile, the internal mixer 42 mixes the core flow 36 with fan bypass air 39. The tailcone mixer 112 then further mixes the exhaust from the internal mixer 42 and, thus, further mixes the core flow 36 with fan bypass air 39. Since the core flow 36 has a lower velocity and is at a lower temperature than the core flow 36, the further mixing of the core flow 36 with fan bypass air 39 by the tailcone mixer 112 further decreases the temperature and the axial velocity of the core flow 36 that exits the internal mixer 42. Accordingly, the further mixing of the exhaust from the internal mixer 42 by the tailcone mixer 112 further reduces the noise of the engine 110. Although the specific amount of noise reduction will depend on various factors, the noise reduction from using the tailcone mixer 112 may be in the range of, for example, approximately 5-7 decibels. Further, the tailcone mixer may be designed so that it does not negatively affect the thrust or efficiency of the engine and may be designed to increase the efficiency of the engine and reduce fuel consumption.

The specific dimensions of the lobes 140 and the main body 120 will vary depending on the engine used and the desired results of using the tailcone mixer 112. It should be understood that the configuration of the tailcone mixer 112 should not be taken as the only configuration and dimensional relationships that are possible under the broader invention of the tailcone mixer 112 disclosed herein.

FIG. 30 illustrates another embodiment in tailcone mixer 312, which is substantially identical to tailcone mixer 112 as set forth above except that tailcone mixer 312 further includes lobes 340 that have adjusting mechanisms such as rod spacer assembly 374. The rod spacer assembly 374 is substantially identical to the rod spacer assembly 74 illustrated in FIGS. 17-19 and disclosed above with respect to the external jet nozzle mixer 20. Each of the lobes 340 may employ an adjusting mechanism such as rod spacer assembly 374 to have the same adjusting effect as described above with respect to rod spacer assembly 74. The adjusting mechanism 374 would preferably be attached between the inner legs, for example, of each lobe 340 to selectively adjust the spacing between the two legs of each lobe 340. As with the adjusting mechanism 74 set forth above with respect to FIGS. 17-19, the adjusting mechanism 374 for lobes 340 may include a rod spacer having a first end of stud 376 fastened to a first side leg 348 and a second end of stud 376 coupled to a barrel nut and attached to the second side leg (not shown) and with the ends of adjusting mechanism 374 being selectively movable relatively to each other. Tailcone mixer 312 contains substantially all of the elements of tailcone mixer 112, including main body 120 and lobes 340 having two legs (inner leg 349 shown) and upper section 350. FIG. 30 also illustrates that a preferably solid end cone 134 may be attached to the rear end of 124 of the main body 120 of mixer 312 to provide additional weight and/or additional aerodynamic characteristics.

FIG. 31 illustrates yet another embodiment of the subject invention in tailcone mixer 412. FIG. 31 illustrates a tailcone mixer 412 that is formed using lobes 440 that are applied directly onto an existing tailcone 447. The lobes 440 may be configured in a manner substantially identical to that described above with respect to lobes 140, but instead of being attached to a main body 120 as are lobes 140, the lobes 440 are attached to an existing tailcone 447 without the need of replacing the existing tailcone 447 with a main body 120 as described above. The lobes 440 attached to the existing tailcone 447 may be substantially identical to the lobes 140 attached to the main body 120 as described above except for being appropriately configured to attach to the existing tailcone 447. The existing tailcone includes a main body 420. Lobes 440 include two legs with inner leg 449 illustrated, along with upper section 350. FIG. 31 also illustrates a solid end cone 434 attached to the rear end of 424 of the main body 420 of mixer 412 to provide additional weight and/or additional aerodynamic characteristics. Although the lobes 440 are illustrated as being connected to the main body 420 and to the end cone 434 it should be understood that the lobes 440 may be attached only to the main body 420 as in the other tailcone mixers described herein, such as in tailcone mixer 112. Further lobes 440 may be attached only to the end cone 434.

The lobes 440 may be attached to the existing tailcone 447 in any appropriate manner, such as welding. The lobes 240 may be attached by removing the tailcone 447 from the inner duct 114, securing the lobes 440 to the tailcone 447, such as by welding, and reattaching the tailcone 447 to the inner duct 114. Another method of utilizing lobes 440 is to secure lobes 440 to an existing tailcone 447, then replace an existing tailcone not having lobes with the pre-made tailcone mixer 412.

The tailcone mixers 112, 212, 312, and 412, including their respective main bodies and lobes may be made from any appropriate material, such as Inconel 625.

It is to be understood that, in the foregoing exposition where dimensions, areas, etc., are expressed in English system units and, parenthetically, in metric system units, the English unit system shall take precedence in the event of any error in conversion from the English unit system to the metric unit system.

Although the invention has been described with respect to a particular embodiment thereof, it should be realized that various changes and modifications may be made therein without departing from the spirit and scope of the invention. While the invention as shown in the drawings and described in detail herein discloses arrangements of elements of particular construction and configuration for illustrating preferred embodiments of structure and method of operation of the present invention, it is to be understood, however, that elements of different construction and configuration and other arrangements thereof, other than those illustrated and described, may be employed in accordance with the spirit of this invention, and such changes, alternations and modifications as would occur to those skilled in the art are considered to be within the scope of this invention as broadly defined in the appended claims.

What is claimed is:

1. A tailcone for an engine, comprising:
a main body having a wider forward end and a more narrow rear end and a mid-portion extending between said forward end and said rear end, said forward end being structured and arranged for attachment to an inner duct case, said rear end being closed, and said mid-portion having a first sloping contour from said forward end to said rear end; and
lobes rigidly secured to said mid-portion, each of said lobes having an inner section and an outer section that extend from a forward section, said forward section being adjacent said mid-portion of said main body, said inner section extending from said forward section towards said rear end of said main body while substantially following said first sloping contour of said mid-portion of said main body, said outer section extending rearwardly from said forward section and having a second sloping contour that gradually diverges from said first sloping contour of said mid-portion.

2. A tailcone according to claim 1, wherein
said main body is hollow.

3. A tailcone according to claim 1, wherein
each of said forward end and said rear end of said main body are substantially circular in transverse cross-section.

4. A tailcone according to claim 1, wherein
said forward end of said main body includes holes for attaching said main body to the inner duct.

5. A tailcone according to claim 1, wherein
said first sloping contour includes a first curved section, and said second sloping contour includes a second curved section.

6. A tailcone according to claim 1, wherein
each of said lobes has a generally U-shaped transverse cross-section with said inner sections including two inner legs.

7. A tailcone according to claim 1, wherein
each of said lobes is an integrally-formed, one-piece element.

8. A tailcone according to claim 1, wherein
said lobes include six, spaced lobes.

9. A tailcone according to claim 1, wherein
each of said lobes is generally elliptically shaped and said lobes are evenly spaced from one another.

10. A tailcone according to claim 1, wherein
each of said lobes includes a first side and a second side and an adjusting mechanism coupled between said first and second sides to selectively adjust the spacing between said first and second sides.

11. A tailcone according to claim 1, wherein
said adjusting mechanism is a rod spacer having a first end fastened to said first side and a second end fastened to said second side with said first and second ends being selectively movable relatively to each other.

12. A tailcone according to claim 1, wherein
said main body includes a solid cone rigidly attached to said rear end.

13. A jet engine assembly, comprising:
an outer duct;
an inner duct positioned within said outer duct;
a first noise reducing device positioned between said inner and outer ducts;
a tailcone rigidly secured to a rear end of said inner duct, said tailcone having a main body and including a second noise reducing device protruding from said main body between said main body and said outer duct.

14. An assembly according to claim 13, wherein
said first noise reducing device is a first mixer adapted to mix hot exhaust air with other air.

15. An assembly according to claim 14, wherein
said second noise reducing device is a mixer adapted to mix exhaust air downstream from said first mixer.

16. An assembly according to claim 13, wherein
said second noise reducing device includes a plurality of lobes rigidly attached to said main body of said tailcone.

17. An assembly according to claim 16, wherein
said main body has a wider forward end and a more narrow rear end and a mid-portion extending between said forward end and said rear end, said forward end being structured and arranged for attachment to said inner duct, said rear end being closed, and said mid-portion having a sloping contour from said forward end to said rear end; and
each of said plurality of lobes has an inner section and an outer section that extend from a forward section, said forward section being adjacent said mid-portion of said main body, said inner section extending from said forward section towards a rear end of said main body while substantially following said contour of said mid-portion of said main body, said outer section extending rearwardly from said forward section and having a curved contour that gradually diverges from said sloping contour of said mid-portion.

18. An assembly according to claim 13, further comprising:
a third noise reducing device coupled to said outer duct to receive gas exhausted from said first and second noise reducing devices.

19. An assembly according to claim 18, wherein
said third noise reducing device is a mixer.

20. A jet engine assembly, comprising:
an outer duct;
an inner duct positioned within said outer duct;
a first air mixer positioned between said inner and outer ducts;
means rigidly attached to a rear end of said inner duct and positioned within said outer duct for further mixing air and reducing noise.

21. An airplane, comprising:
a main aircraft body; and
an engine assembly coupled to said main body, said engine assembly including:
an outer duct;
an inner duct positioned within said outer duct;
a first mixer positioned between said inner and outer ducts;
a tailcone rigidly secured to a rear end of said inner duct, said tailcone having a main tailcone body and including a second mixer protruding from said main tailcone body between said main tailcone body and said outer duct.

22. An airplane according to claim 21, wherein
said main tailcone body has a wider forward end and a more narrow rear end and a mid-portion extending between said forward end and said rear end, said forward end being structured and arranged for attachment to said inner duct, said rear end being closed, and said mid-portion having a sloping contour from said forward end to said rear end; and
said second mixer including a plurality of lobes, each of said plurality of lobes has an inner section and an outer section that extend from a forward section, said forward section being adjacent said mid-portion of said main tailcone body, said inner section extending from said forward section towards a rear end of said main tailcone body while substantially following said contour of said mid-portion of said main tailcone body, said outer section extending rearwardly from said forward section and having a curved contour that gradually diverges from said sloping contour of said mid-portion.

23. A method of repairing an engine, comprising:
providing an engine and a first mixer coupled to the engine, the first mixer being positioned in a housing and adapted to mix hot engine air with other air; and
repairing the engine in order to decrease engine noise, increase fuel efficiency, or reduce exhaust temperature by attaching a second mixer to the rear end of an inner duct positioned within said housing, the second mixer forming an extension from a main body of a tailcone.

24. A method according to claim 23, wherein
the repairing the engine includes removing an existing tailcone and replacing the existing tailcone with another tailcone that includes the second mixer.

25. A method of improving operation of an engine, comprising:
providing an engine enclosed within a housing, the housing having an exhaust aperture, and a first mixer coupled to the engine and located within the housing, the first mixer including first elements to mix exhaust gas with cooling air; and
attaching a tailcone mixer to the rear end of an inner duct that is positioned within the housing, the tailcone mixer having second elements to mix exhaust from the first mixer and form tailcone for the engine.

26. A method of retrofitting a pre-existing engine assembly, comprising:
providing a pre-existing engine enclosed within a housing, and a first mixer coupled to the pre-existing engine and being located within the housing, the first mixer including first elements to mix exhaust gas with cooling air, the housing having a pre-existing tailcone attached to the rear end of an inner duct that is positioned within the housing;
removing the pre-existing tailcone; and
attaching a tailcone mixer to the rear end of the inner duct, the tailcone mixer mixing exhaust from the first mixer.
